(19) United States
(12) Patent Application Publication
(10) Pub. No.: US 2015/0174509 A1
(43) Pub. Date: Jun. 25, 2015

(54) FILTER MEDIA WITH FINE STAPLE FIBERS

(71) Applicant: Hollingsworth & Vose Company, East Walpole, MA (US)

(72) Inventor: Sneha Swaminathan, Nashua, NH (US)

(73) Assignee: Hollingsworth & Vose Company, East Walpole, MA (US)

(21) Appl. No.: 14/137,152

(22) Filed: Dec. 20, 2013

(51) Int. Cl. B01D 29/01; B01D 39/16; B01D 39/20

(52) U.S. Cl. CPC B01D 29/01; B01D 39/2017; B01D 39/1623

(57) ABSTRACT

Filter media, including those suitable for hydraulic applications, and related components, systems, and methods associated therewith are provided. In some embodiments, a filter media may include a non-woven layer comprising blend of glass fibers and polymeric staple fibers. The polymeric staple fibers may have a relatively small diameter. The non-woven layer comprising the fiber may have desirable properties such as one or more of a low micron rating for beta efficiency, high dust holding capacity, and/or a low resistance to fluid flow. In certain embodiments, the filter media may include two or more layers, at least one of the layers including a non-woven layer comprising the fiber blend. In some such cases, the filter media may include one or more layers that serve to enhance the overall properties of the filter media.

### FIELD OF INVENTION

The present invention relates generally to filter media which may be used in a variety of applications, including hydraulic applications, and, more particularly, to multilayered filter media which have desirable performance characteristics.

### BACKGROUND

Filter media can be used to remove contamination in a variety of applications. Depending on the application, the filter media may be designed to have different performance characteristics. For example, filter media may be designed to have performance characteristics suitable for hydraulic applications which involve filtering contamination in pressurized fluids.

In general, filter media can be formed of a web of fibers. For example, the web may include microglass fibers amongst other components. The fiber web provides a porous structure that permits fluid (e.g., hydraulic fluid) to flow through the filter media. Contaminant particles contained within the fluid may be trapped on the fibrous web. Filter media characteristics, such as fiber diameter and basis weight, affect filter performance including filter efficiency, dust holding capacity (i.e., dirt holding capacity) and resistance to fluid flow through the filter.

There is a need for filter media that can be used in a variety of applications, including hydraulic applications, which has a desirable balance of properties including a high dust holding capacity and a low resistance to fluid flow (high permeability) across the filter media.

### SUMMARY OF THE INVENTION

Filter media, including those suitable for hydraulic and/or other applications, and related components, systems, and methods associated therewith are provided.

In one set of embodiments, a series of filter media are provided. In one embodiment, a filter media comprises a first layer and second layer. The second layer comprises glass fibers and polymeric staple fibers, wherein the polymeric staple fibers have an average fiber diameter of less than or equal to about 10 microns. The glass fibers are present in the second layer in an amount of at least about 0.5 wt % to about 99.5 wt % of the fibers in the second layer. The polymeric staple fibers are present in the second layer in an amount of at least about 0.5 wt % to about 99.5 wt % of the fibers in the second layer. The first layer has a mean flow pore size greater than a mean flow pore size of the second layer.

In another embodiment, a filter media comprises a non-woven layer comprising a blend of glass fibers and polymeric staple fibers, wherein the polymeric staple fibers have an average fiber diameter of less than or equal to about 6 microns.

In another embodiment, a filter media comprises a non-woven layer comprising a blend of glass fibers and polymeric staple fibers, wherein the polymeric staple fibers have an average fiber diameter of less than or equal to about 10 microns, and wherein the polymeric staple fibers are present in an amount of greater than or equal to about 10 wt % of the fibers in the non-woven layer.

In one set of embodiments, methods are provided. A method of filtering a liquid comprising passing a liquid including particulates through a filter media. The filter media can include one of the filter media described above and/or herein.

In other embodiments, a filter element including one of the filter media described above and/or herein is provided.

Other aspects, embodiments, advantages and features of the invention will become apparent from the following detailed description.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows an example of a filter media having multiple layers according to one set of embodiments; and

FIG. 2 shows an example of a filter media having multiple layers according to one set of embodiments.

### DETAILED DESCRIPTION

Filter media, including those suitable for hydraulic applications, and related components, systems, and methods associated therewith are provided. In some embodiments, a filter media described herein may include a layer (e.g., a non-woven layer) comprising a blend of glass fibers and polymeric staple fibers. The polymeric staple fibers may have a relatively small diameter (e.g., less than or equal to about 10 microns). In some embodiments, the layer comprising the fiber blend may have desirable properties including one or more of a high dust holding capacity, a high efficiency, e.g., a low micron rating for beta efficiency, and/or a low resistance to fluid flow. In certain embodiments, the filter media may include two or more layers, at least one of the layers comprising a blend of glass fibers and polymeric staple fibers. In some such cases, the filter media may include one or more layers (e.g., a pre-filter layer) that serve to enhance the overall properties of the filter media (e.g., dust holding capacity, mechanical properties).

In certain embodiments, the filter media may include at least one layer having a relatively high percentage of microglass fibers. The layer having a relatively high percentage of microglass fibers may be part of a multi-layer media, such a dual-layer pre-filter, in some embodiments. In other embodiments, a multi-layer media may include a layer having a relatively low percentage of glass fibers, and instead may include a relatively high percentage of polymeric fibers (e.g., synthetic polymer fibers).

Certain filter media described herein may have desirable properties including high dust holding capacity, high efficiency (e.g., a low micron rating for beta efficiency), and low resistance to fluid flow. The media may be incorporated into a variety of filter element products including hydraulic filters.

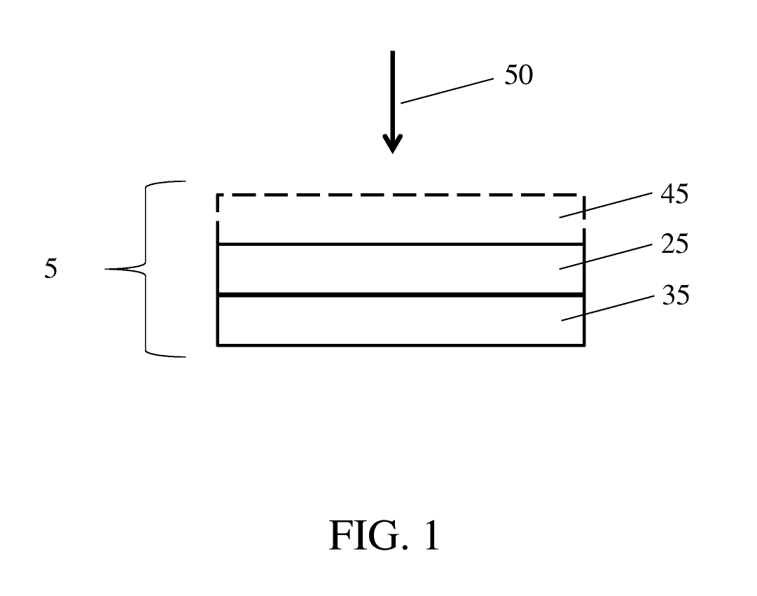

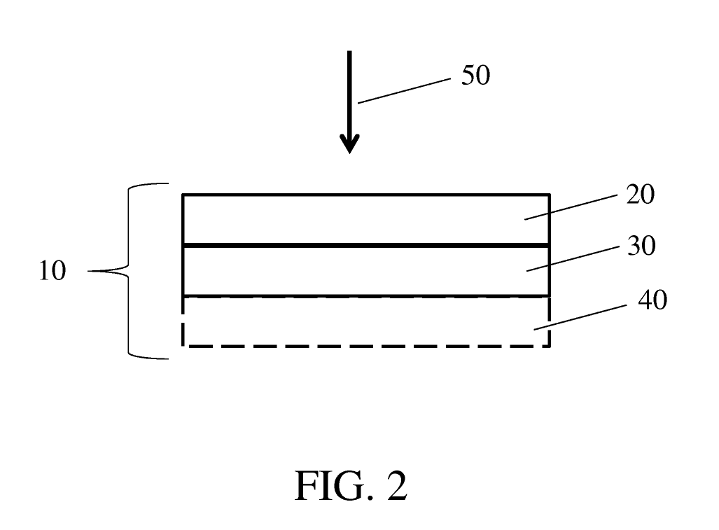

Non-limiting examples of filter media described herein are shown illustratively in FIGS. 1 and 2. As shown in the embodiment illustrated in FIG. 1, a filter media 5 includes a first layer 25 adjacent a second layer 35. Optionally, filter media 5 can include a third layer 45 adjacent the first layer. In some embodiments, as illustrated in FIG. 2, a filter media 10 includes a first layer 20 adjacent a second layer 30 and optionally, a third layer 40 adjacent the second layer. Additional layers, e.g., fourth, fifth, or sixth layers (e.g., up to 10 layers), may also be included in some cases. The orientation of filter media 5 or 10 relative to fluid flow through the media can generally be selected as desired. As shown illustratively in FIGS. 1 and 2, the first layer is upstream of the second layer in the direction of fluid flow indicated by arrow 50. In other embodiments, however, the first layer is downstream of the second layer in the direction of fluid flow through the filter media.

As used herein, when a layer is referred to as being “adjacent” another layer, it can be directly adjacent the layer, or an intervening layer also may be present. A layer that is “directly adjacent” or “in contact with” another layer means that no intervening layer is present.

In some cases, each of the layers of the filter media has different characteristics and filtration properties that, when combined, result in desirable overall filtration performance, for example, as compared to a filter media having a single-layer structure. For example, in one set of embodiments, the first layer (e.g., layer 20, layer 25) is a pre-filter layer (also known as a “loading layer”) and the second layer (e.g., layer 30, layer 35) is a main filter layer (also known as an “efficiency layer”). Generally, a pre-filter layer is formed using coarser fibers, and therefore has a lower resistance to fluid flow, than that of a main filter layer. The one or more main filter layers may include finer fibers (e.g., small diameter polymeric staple fibers, glass fibers) and may have a higher resistance to fluid flow and/or a smaller mean flow pore size than that of a pre-filter layer. As such, a main filter layer can generally trap particles of smaller size compared to the pre-filter layer. In one example, filter media 5 of FIG. 1 includes one or more pre-filter layers (e.g., layers 25 and/or 45) and a main filter layer (e.g., layer 35) comprising a blend of glass fibers and polymeric staple fibers having a relatively small diameter (e.g., less than or equal to about 10 microns, less than or equal to about 6 microns, or less than or equal to about 1 micron). The main filter layer may be formed of fibers having a smaller average fiber diameter than that of the one or more pre-filter layers.

In some embodiments, where a third layer is present, e.g., as illustrated in FIG. 1, the third layer may be an additional pre-filter layer that has the same or different properties as first layer 25. For example, the third layer may have even coarser fibers and a lower resistance to fluid flow than that of first layer 25. In other embodiments, where third layer 40 is present as illustrated in FIG. 2, the third layer may be an additional main filter layer that has the same or different properties as second layer 30. For example, the third layer may have even finer fibers and a higher resistance to fluid flow than that of second layer 30. In some embodiments, the third layer comprises a blend of glass fibers and synthetic polymer fibers as described in more detail below.

The filter media can also have other configurations of first, second, and optionally third or more layers. For instance, in some cases filter media 10 does not include a pre-filter layer. In some such embodiments, the first layer (e.g., layer 20, layer 25) is an upstream main filter layer and second layer (e.g., layer 30, layer 35) is a main filter layer downstream of the first layer. Optionally, the filter media can include a third layer 40 (e.g., another main filter layer) positioned downstream of the second layer or a third layer 45 (e.g., another main filter layer) positioned upstream of the first layer. In some embodiments, an upstream layer may have coarser fibers, and therefore a lower resistance to fluid flow, than that of a layer downstream of that layer. In some cases, the resistance of each layer increases successively from the furthest upstream layer to the furthest downstream layer.

In some embodiments, a layer having relatively coarse fibers may be positioned between two layers having relatively finer fibers. Other configurations are also possible. Additionally, a filter media may include any suitable number of layers, e.g., at least 2, 3, 4, 5, 6, 7, 8, or 9 layers (e.g., up to 10 layers), depending on the particular application and performance characteristics desired.

As noted above, each of the layers of the filter media can have different properties. For instance, the first and second layers can include fibers having different characteristics (e.g., fiber diameters, fiber compositions, and/or fiber lengths). Fibers with different characteristics can be made from one material (e.g., by using different process conditions) or different materials (e.g., glass fibers, synthetic fibers (e.g., organic polymer fibers), and combinations thereof). Without wishing to be bound by theory, it is believed that a filter media having a multilayered structure with layers including different characteristics exhibits significantly improved performance properties such as dirt holding capacity and/or efficiency compared to a filter media having a single-layered structure.

In some embodiments, a filter media described herein may comprise a pre-filter including one or more layers (e.g., a first layer and/or a third layer) and a main filtration layer (e.g., a second layer) comprising glass fibers and polymeric staple fibers. The main filtration layer and/or pre-filter layer(s) may optionally be formed on a scrim or supporting layer. The filter media may be arranged such that the main filtration layer (e.g., second layer) is positioned downstream of the one or more pre-filter layers. The one or more pre-filter layers may be wet-laid layer(s) (e.g., a layer formed by a wet laid process) or non-wet laid layer(s) (e.g., it may include meltblown fibers, meltspun fibers, centrifugal spun fibers, air-laid fibers, dry-laid fibers, or fibers formed by other non-wet laid processes). For instance, a pre-filter layer may comprise a layer of continuous fibers (e.g., meltblown fibers, meltspun fibers, centrifugal spun fibers). In some instances, the layer of continuous fibers may be manufactured and adhered to another layer (e.g., a scrim, a multi-layered filter media, a single phase layer, a multiphase layer) in any appropriate manner. A layer including continuous fibers may be positioned downstream or upstream with respect to the layer on which it is adhered.

In other embodiments, the pre-filter may comprise one or more (e.g., two) layers comprising glass fibers (e.g., at least about 80 wt % glass fibers). In some such embodiments, the main filtration layer may comprise one or more polymeric staple fibers having an average diameter of less than or equal to about 10 microns (e.g., less than or equal to about 6 microns, less than or equal to about 4 microns, less than or equal to about 3 microns, less than or equal to about 1 micron) and glass fibers having an average diameter of, for example, less or equal to about 11 microns. Other ranges of possible fiber diameters are provided herein. Other types of fibers can also be included in place of or in addition to the polymeric staple fibers and/or glass fibers.

In some embodiments, the main filtration layer (e.g., second layer) may comprise a significant amount of polymeric staple fibers. For instance, the polymeric staple fibers may be present in an amount of greater than or equal to about 10 wt % of the fibers in the main filtration layer (e.g., second layer). It should be appreciated, however, that other values are also possible. For instance, the polymeric staple fibers may be present in the main filtration layer (e.g., second layer) in an amount of at least about 0.5 wt % to about 99.5 wt % of the fibers in the main filtration layer. In some such embodiments, the glass fibers may be present in the main filtration layer in an amount of at least about 0.5 wt % to about 99.5 wt % of the fibers in the main filtration layer.

In some embodiments in which the filter media comprises a pre-filter including one or more layers and a main filtration layer comprising a blend of glass fibers and polymeric staple fibers, the filter media may have beneficial properties. For instance, the filter media may have a relatively high dust holding capacity (e.g., between about 5 gsm and about 300 gsm) for a given basis weight, a relatively low micron rating for beta 200 efficiency (e.g., less than or equal to about 30 microns, less than or equal to about 15 microns, less than or equal to about 10 microns, less than or equal to about 8 microns), a relatively low pressure drop (e.g., less than or equal to about 4.5 kPa), and/or a mean flow pore size between about 0.1 microns and about 10 microns. In some such cases, the mean flow pore size of the one or more pre-filter layers may greater than the mean flow pore size of the main filtration layer.

In certain embodiments, one or more layers of the filter media includes microglass fibers, chopped strand glass fibers, or a combination thereof. Microglass fibers and chopped strand glass fibers are known to those skilled in the art. One skilled in the art is able to determine whether a glass fiber is microglass or chopped strand by observation (e.g., optical microscopy, electron microscopy). Microglass fibers may also have chemical differences from chopped strand glass fibers. In some cases, though not required, chopped strand glass fibers may contain a greater content of calcium or sodium than microglass fibers. For example, chopped strand glass fibers may be close to alkali free with high calcium oxide and alumina content. Microglass fibers may contain 10-15% alkali (e.g., sodium, magnesium oxides) and have relatively lower melting and processing temperatures. The terms refer to the technique(s) used to manufacture the glass fibers. Such techniques impart the glass fibers with certain characteristics. In general, chopped strand glass fibers are drawn from bushing tips and cut into fibers in a process similar to textile production. Chopped strand glass fibers are produced in a more controlled manner than microglass fibers, and as a result, chopped strand glass fibers will generally have less variation in fiber diameter and length than microglass fibers. Microglass fibers are drawn from bushing tips and further subjected to flame blowing or rotary spinning processes. In some cases, fine microglass fibers may be made using a remelting process. In this respect, microglass fibers may be fine or coarse. As used herein, fine microglass fibers are less than 1 micron in diameter and coarse microglass fibers are greater than or equal to 1 micron in diameter.

The microglass fibers of one or more layers can have small diameters such as less than 10.0 microns. For example, the average diameter of the microglass fibers in a layer may be between 0.1 microns to about 9.0 microns; and, in some embodiments, between about 0.3 microns and about 6.5 microns, or between about 1.0 microns and 5.0 microns. In certain embodiments, the microglass fibers may have an average fiber diameter of less than or equal to about 7.0 microns, less than or equal to about 5.0 microns, less than or equal to about 3.0 microns, or less than or equal to about 1.0 microns. Average diameter distributions for microglass fibers are generally log-normal. However, it can be appreciated that microglass fibers may be provided in any other appropriate average diameter distribution (e.g., Gaussian distribution).

The microglass fibers may vary significantly in length as a result of process variations. The aspect ratios (length to diameter ratio) of the microglass fibers in a layer may be generally in the range of about 100 to 10,000. In some embodiments, the aspect ratio of the microglass fibers in a layer are in the range of about 200 to 2500; or, in the range of about 300 to 600. In some embodiments, the average aspect ratio of the microglass fibers in a layer may be about 1,000; or about 300. It should be appreciated that the above-noted dimensions are not limiting and that the microglass fibers may also have other dimensions.

Coarse microglass fibers, fine microglass fibers, or a combination of microglass fibers thereof may be included within a layer. In some embodiments, coarse microglass fibers make up between about 20% by weight and about 90% by weight of the glass fibers. In some cases, for example, coarse microglass fibers make up between about 30% by weight and about 60% by weight of the glass fibers, or between about 40% by weight and about 60% by weight of the glass fibers. For certain embodiments that include fine microglass fibers, the fine microglass fibers make up between about 0% and about 95% by weight of the glass fibers. In some cases, for example, fine microglass fibers make up between about 5% by weight and about 60% by weight of the glass fibers, between about 30% by weight and about 50% by weight of the glass fibers, or between about 60% by weight and about 95% by weight of the glass fibers.

The chopped strand glass fibers may have an average fiber diameter that is greater than the diameter of the microglass fibers. In some embodiments, the chopped strand glass fiber has a diameter of greater than about 5 microns. For example, the diameter range may be up to about 30 microns. In some embodiments, the chopped strand glass fibers may have a fiber diameter between about 5 microns and about 12 microns. In certain embodiments, the chopped strand fibers may have an average fiber diameter of less than or equal to about 10.0 microns, less than or equal to about 8.0 microns, less than or equal to about 6.0 microns. Average diameter distributions for chopped strand glass fibers are generally log-normal. Chopped strand diameters tend to follow a normal distribution. Though, it can be appreciated that chopped strand glass fibers may be provided in any appropriate average diameter distribution (e.g., Gaussian distribution). In some embodiments, chopped strand glass fibers may have a length in the range of between about 0.125 inches and about 1 inch (e.g., about 0.25 inches, or about 0.5 inches).

In some embodiments, regardless of whether the glass fibers in a layer (e.g., an upstream layer, a downstream layer, a first layer, a second layer, a third layer, etc.) are microglass fibers, chopped strand fibers, or combinations thereof, the average fiber diameter of glass fibers within a layer may be greater than or equal to about 0.1 microns, greater than or equal to about 0.2 microns, greater than or equal to about 0.3 microns, greater than or equal to about 0.5 microns, greater than or equal to about 1 micron, greater than or equal to about 2 microns, greater than or equal to about 4 microns, greater than or equal to about 6 microns, greater than or equal to about 8 microns, greater than or equal to about 10 microns, or greater than or equal to about 12 microns. In some instances, the average fiber diameter of glass fibers within a layer (e.g., an upstream layer, a downstream layer, a first layer, a second layer, a third layer, etc.) may be less than or equal to about 15 microns, less than or equal to about 13 microns, less than or equal to about 11 microns, less than or equal to about 8 microns, less than or equal to about 5 microns, less than or equal to about 3 microns, less than or equal to about 1 micron, or less than or equal to about 0.5 microns. Combinations of the above-referenced ranges are also possible (e.g., greater than or equal to about 0.1 microns and less than or equal to about 15 microns, greater than or equal to about 0.3 microns and less than or equal to about 11 microns).

It should be appreciated that the above-noted dimensions are not limiting and that the microglass and/or chopped strand fibers may also have other dimensions.

In certain embodiments, the ratio between the weight percentage of microglass fibers and chopped strand glass fibers provides for different characteristics in the filter media. Accordingly, in some embodiments, one or more layers of a filter media (e.g., an upstream layer, a downstream layer, a first layer, a second layer, a third layer, etc.) includes a relatively large percentage of microglass fibers in the layer. For example, at least 70 wt %, or at least 80 wt %, at least 90 wt %, at least 93 wt %, at least 95 wt %, at least 97 wt %, or at least 99 wt % of the fibers of a layer may be microglass fibers. In certain embodiments, all of the fibers of a layer are microglass fibers. In some embodiments, one or more layers of a filter media (e.g., an upstream layer, a downstream layer, a first layer, a second layer, a third layer, etc.) includes a relatively high percentage of chopped strand fibers in the layer. For example, at least 50 wt %, at least 60 wt %, at least 70 wt %, or at least 80 wt %, at least 90 wt %, at least 93 wt %, at least 95 wt %, at least 97 wt %, or at least 99 wt % of the fibers of a layer may be chopped strand fibers. Such percentages of chopped strand fibers may be particularly useful in certain embodiments for micron ratings greater than 15 microns for Beta₍ₓ₎=200. In certain embodiments, all of the fibers of a layer are chopped strand fibers.

In some embodiments, one or more layers of a filter media (e.g., an upstream layer, a downstream layer, a first layer, a second layer, a third layer, etc.) includes a relatively large percentage of microglass fiber in the layer with respect to all of the components used to form the layer. For example, one or more layers may include microglass fibers of at least about 40 wt %, at least about 50 wt %, at least about 60 wt %, at least about 70 wt %, or at least about 80 wt %, at least about 90 wt %, at least about 93 wt %, at least about 95 wt %, at least about 97 wt %, or at least about 99 wt % of the fibers in a layer. In one particular embodiment, one or more layers includes microglass fibers of between about 90 wt % and about 99 wt %, e.g., between about 90 wt % and about 95 wt % of the fibers in a layer. In another embodiment, one or more layers includes microglass fibers of between about 40 wt % to about 80 wt %, or between about 60 wt % to about 80 wt % of the fibers in a layer. It should be understood that, in certain embodiments, one or more layers of the filter media do not include microglass fibers within the above-noted ranges or at all.

Any suitable amount of chopped strand fibers can be used in one or more layers of a filter media. In some cases, one or more layers includes a relatively low percentage of chopped strand fibers. For example, one or more layers may include chopped strand fiber of less than 30 wt %, or less than 20 wt %, or less than 10 wt %, or less than 5 wt %, or less than 2 wt %, or less than 1 wt % of the fibers in a layer. In some cases, one or more layers of a filter media does not include any chopped strand fibers. It should be understood that, in certain embodiments, one or more layers of the filter media do not include chopped strand fibers within the above-noted ranges.

One or more layers of a filter media may also include microglass fibers having an average fiber diameter within a certain range and making up a certain range of weight percentage of the layer. For instance, one or more layers of a filter media may include microglass fibers having an average fiber diameter of less than 5 microns making up less than or equal to about 50%, less than or equal to about 40%, less than or equal to about 30%, less than or equal to about 20%, less than or equal to about 10%, or less than or equal to about 5% of the microglass fibers of the layer. In some cases, a layer includes 0% of microglass fibers having an average diameter of less than 5 microns. Additionally or alternatively, the one or more layers of the filter media may include microglass fibers having an average fiber diameter of greater than or equal to 5 microns making up greater than about 50%, greater than about 60%, greater than about 70%, greater than about 80%, greater than about 90%, greater than about 93%, or greater than about 97% of the microglass fibers of the layer. In some cases, more than one layer of a filter media includes such properties. It should be understood that, in certain instances, one or more layers of the filter media include microglass fibers within ranges different than those described above.

In other embodiments, one or more layers of a filter media includes relatively fine fibers. For instance, one or more layers of the filter media may include microglass fibers having an average fiber diameter of less than 5 microns making up greater than about 50%, greater than about 60%, greater than about 70%, greater than about 80%, greater than about 90%, greater than about 93%, or greater than about 97% of the microglass fibers of the layer. Additionally or alternatively, the one or more layers of the filter media may include microglass fibers having an average fiber diameter of greater than or equal to 5 microns making up less than or equal to about 50%, less than or equal to about 40%, less than or equal to about 30%, less than or equal to about 20%, less than or equal to about 10%, or less than or equal to about 5% of the microglass fibers of the layer. In some cases, a layer includes 0% of microglass fibers having an average diameter of greater than or equal to 5 microns. In some cases, more than one layer of a filter media includes such properties. It should be understood that, in certain instances, one or more layers of the filter media include microglass fibers within ranges different than those described above.

In certain embodiments, regardless of whether the glass fibers in a layer are microglass, chopped strand fibers, or combinations thereof, the weight percentage of glass fibers in one or more layers of the filter media (e.g., a non-woven layer comprising glass fibers and polymeric fibers) may be greater than or equal to about 1%, greater than or equal to about 2%, greater than or equal to about 4%, greater than or equal to about 8%, greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, greater than or equal to about 50%, greater than or equal to about 60%, greater than or equal to about 70%, or greater than or equal to about 80% of the fibers in a layer. In some instances, the weight percentage of glass fibers in a layer may be less than or equal to about 99%, less than or equal to about 97%, less than or equal to about 95%, less than or equal to about 92%, less than or equal to about 90%, less than or equal to about 85%, less than or equal to about 80%, less than or equal to about 75%, less than or equal to about 70%, less than or equal to about 60%, less than or equal to about 55%, less than or equal to about 50%, less than or equal to about 45%, less than or equal to about 40%, less than or equal to about 35%, or less than or equal to about 30%, less than or equal to about 25%, less than or equal to about 20%, less than or equal to about 15%, less than or equal to about 10%, less than or equal to about 5%, less than or equal to about 3%, or less than or equal to about 2% of the fibers in the layer. Combinations of the above-referenced ranges are possible (e.g., a weight percentage of greater than or equal to about 1% and less than or equal to about 99% of the fibers in the layer, or greater than or equal to about 4% and less than or equal to about 95% of the fibers in the layer).

In certain embodiments, regardless of whether the glass fibers in a layer are microglass or chopped fibers, one or more layers of a filter media includes a large percentage of glass fiber (e.g., microglass fibers and/or chopped strand glass fibers). For example, one or more layers (e.g., the first and/or second layers) may comprise at least about 40 wt %, at least about 50 wt %, at least about 60 wt %, at least about 70 wt %, at least about 80 wt %, at least about 90 wt %, or at least about 95 wt % of glass fiber based on the total amount of fibers in the layer. In some cases, all of the fibers of a layer (e.g., the first and/or second layers) are formed of glass. It should be understood that, in certain embodiments, one or more layers of the filter media do not include glass fiber within the above-noted ranges or at all.

In some embodiments, regardless of whether the fibers in a layer are glass fibers (e.g., microglass or chopped fibers) and/or synthetic fibers, fibers having a fiber diameter less than or equal to 7 microns make up greater than about 60% by weight of the fibers, greater than about 70% by weight of the fibers, or greater than about 80% by weight of the fibers of a layer. In some cases, fibers having a fiber diameter less than or equal to 5 microns make up greater than about 60% by weight of the fibers, greater than about 70% by weight of the fibers, or greater than about 80% by weight of the fibers of a layer. In some cases, fibers having a fiber diameter less than or equal to 3 microns make up greater than about 50% by weight of the fibers, greater than about 60% by weight of the fibers, or greater than about 70% by weight of the fibers of a layer.

In one particular set of embodiments, regardless of whether the fibers in a layer are glass fibers (e.g., microglass or chopped fibers) and/or synthetic fibers, a filter media includes a first layer (e.g., a pre-filter layer) having an average fiber diameter of between about 1.0 microns and about 20.0 microns, e.g., about 1.0 microns and about 10.0 microns, between about 1.0 micron and about 8.0 microns. A second layer of the filter media (e.g., a main filter layer) may have an average fiber diameter of between about 1.0 micron and about 10.0 microns, e.g., between about 0.5 micron and about 6 microns. If the filter media includes a third layer (e.g., downstream of the second layer), the third layer may have an average fiber diameter of between about 0.1 microns and about 6.0 microns, e.g., between about 0.8 micron and about 5.0 microns, between about 0.5 micron and about 2.5 microns or between about 0.1 and about 1.5 microns. Other ranges are also possible. Additional layers are also possible.

As described herein, in some embodiments, a layer of the filter media (e.g., a second layer or a third layer, such as a main filtration layer) may comprise a blend of glass fibers and polymeric staple fibers having a relatively small diameter. In some embodiments, the polymeric staple fibers in a layer may have an average diameter of less than or equal to about 20 microns, less than or equal to about 15 microns, less than or equal to about 10.5 microns, less than or equal to about 10 microns, less than or equal to about 8 microns, less than or equal to about 6 microns, less than or equal to about 4 microns, less than or equal to about 3 microns, less than or equal to about 2 microns, less than or equal to about 1 micron, less than or equal to about 0.9 microns, less than or equal to about 0.8 microns, less than or equal to about 0.6 microns, less than or equal to about 0.5 microns, less than or equal to about 0.4 microns, or less than or equal to about 0.2 microns. In some instances, the average fiber diameter of the polymeric stable fibers within a layer may be greater than or equal to about 0.1 microns, greater than or equal to about 0.2 microns, greater than or equal to about 0.3 microns, greater than or equal to about 0.5 microns, greater than or equal to about 1 micron, greater than or equal to about 2 microns, greater than or equal to about 4 microns, greater than or equal to about 6 microns, or greater than or equal to about 8 microns. Combinations of the above-referenced ranges are also possible. For instance, in certain embodiments, the average diameter of the polymeric staple fibers may be, for example, between about 0.1 microns and about 10.5 microns, between about 0.25 microns and about 10 microns, between about 0.5 microns and about 10 microns, between about 1 micron and about 10 microns, between about 0.1 microns and about 6 microns, between about 0.25 microns and about 6 microns, between about 0.5 microns and about 6 microns, between about 1 micron and about 6 microns, between about 0.1 microns and about 3 microns, between about 0.2 microns and about 3 microns, between about 0.5 micron and about 3 microns, or between about 1 micron and about 3 microns. Average diameters of less than 1 micron are also possible (e.g., between about 0.2 microns to about 1 micron, between about 0.3 microns to about 0.9 microns).

Generally, the polymeric stable fibers are non-continuous fibers. That is, the polymeric staple fibers are generally cut (e.g., from a filament) or formed as non-continuous discrete fibers to have a particular length or a range of lengths. In some embodiments, the polymeric staple fibers may have a length of less than or equal to about 55 mm, less than or equal to about 40 mm, less than or equal to about 20 mm, less than or equal to about 10 mm, less than or equal to about 5 mm, less than or equal to about 3 mm, less than or equal to about 2 mm, less than or equal to about 1 mm, less than or equal to about 0.75 mm, less than or equal to about 0.5 mm, less than or equal to about 0.2 mm, or less than or equal to about 0.1 mm. In some instances, the polymeric staple fibers may have a length of greater than or equal to about 0.02 mm, greater than or equal to about 0.03 mm, greater than or equal to about 0.05 mm, greater than or equal to about 0.1 mm, greater than or equal to about 0.2 mm, greater than or equal to about 0.5 mm, greater than or equal to about 0.75 mm, greater than or equal to about 1 mm, greater than or equal to about 5 mm, greater than or equal to about 10 mm, greater than or equal to about 20 mm, or greater than or equal to about 40 mm. Combinations of the above-referenced ranges are possible (e.g., greater than or equal to about 0.02 mm and less than or equal to about 55 mm, greater than or equal to about 0.03 mm and less than or equal to about 55 mm).

In general, the polymeric staple fibers may have any suitable composition. Non-limiting examples of the polymers include polyester (e.g., polycaprolactone), cellulose acetate, polymethyl methacrylate, polystyrene, polyaniline, polypropylene, polyamide, polyaramid (e.g. para-aramid, meta-aramid), polyimide (e.g., polyetherimide), polyethylene, polyether ketone, polyethylene terephthalate, polyolefin, nylon, polyacrylics, polyvinylalcohol, polyether sulfones, poly(phenylene ether sulfone), polysulfones, polyethylenes, polyacrylonitrile, polyvinylidene fluoride, polybutylene terephthalate, poly(lactic acid), polyphenylene oxide, polycarbonate, polyurethane, polycaprolactone, polypyrrole, zein, and combinations or copolymers (e.g., block copolymers) thereof.

The weight percentage of polymeric stable fibers (e.g., polymeric staple fibers having a relatively small diameter) in a layer, such as a non-woven layer, may vary. As described herein, such a layer may include a blend of the polymeric staple fibers with glass fibers. For instance, in some embodiments, the weight percentage of polymeric staple fibers (e.g., polymeric staple fibers having a relatively small diameter) in a layer may be greater than or equal to about 0.5%, greater than or equal to about 1%, greater than or equal to about 3%, greater than or equal to about 5%, greater than or equal to about 8%, greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, greater than or equal to about 50%, greater than or equal to about 60%, greater than or equal to about 70%, or greater than or equal to about 80%, e.g., based on the total amount of fibers in a layer. In some instances, the weight percentage of polymeric staple fibers in a layer may be less than or equal to about 99.5%, less than or equal to about 99%, less than or equal to about 98%, less than or equal to about 96%, less than or equal to about 92%, less than or equal to about 90%, less than or equal to about 85%, less than or equal to about 80%, less than or equal to about 75%, less than or equal to about 70%, less than or equal to about 60%, less than or equal to about 55%, less than or equal to about 50%, less than or equal to about 45%, less than or equal to about 40%, less than or equal to about 35%, less than or equal to about 30%, less than or equal to about 25%, less than or equal to about 20%, less than or equal to about 15%, less than or equal to about 10%, or less than or equal to about 5%, e.g., based on the total amount of fibers in a layer. Combinations of the above-referenced ranges are possible (e.g., greater than or equal to about 1% and less than or equal to about 99%, or greater than or equal to about 5% and less than or equal to about 96%).

In some embodiments, a fiber web may comprise two or more types of polymeric staple fibers that include at least one differing characteristic (e.g., fiber diameter, fiber length, and/or fiber composition) in a blend with glass fibers. For example, the fiber web may comprise polymeric staple fibers having an average diameter of less than 1 micron and polymeric staple fibers having an average diameter of between 1 micron and about 10 microns (e.g., between 1 micron and about 6 microns). In some such embodiments, the weight percentage of polymeric staple fibers in a layer that have a fiber diameter of less than 1 micron may be greater than or equal to about 1%, greater than or equal to about 3%, greater than or equal to about 5%, greater than or equal to about 8%, greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, greater than or equal to about 50%, greater than or equal to about 60%, greater than or equal to about 70%, or greater than or equal to about 80% e.g., based on the total amount of fibers in a layer. In some instances, the weight percentage of polymeric staple fibers having a fiber diameter of less than 1 micron may be less than or equal to about 99%, less than or equal to about 98%, less than or equal to about 96%, less than or equal to about 92%, less than or equal to about 90%, less than or equal to about 85%, less than or equal to about 80%, less than or equal to about 75%, less than or equal to about 70%, less than or equal to about 60%, less than or equal to about 55%, less than or equal to about 50%, less than or equal to about 45%, less than or equal to about 40%, less than or equal to about 35%, or less than or equal to about 30%, less than or equal to about 25%, less than or equal to about 20%, or less than or equal to about 15%, e.g., based on the total amount of fibers in a layer. Combinations of the above-referenced ranges are possible (e.g., greater than or equal to about 3% and less than or equal to about 98%, greater than or equal to about 5% and less than or equal to about 96%).

In some embodiments involving a fiber web comprising two or more types of polymeric staple fibers, the weight percentage of polymeric staple fibers having an average fiber diameter of between 1 micron and about 10 microns (e.g., between 1 micron and about 6 microns) may be greater than or equal to about 1%, greater than or equal to about 3%, greater than or equal to about 5%, greater than or equal to about 8%, greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, greater than or equal to about 50%, greater than or equal to about 60%, greater than or equal to about 70%, or greater than or equal to about 80%, e.g., based on the total amount of fibers in a layer. In some instances, the weight percentage of polymeric staple fibers having an average fiber diameter of between 1 micron and about 10 microns (e.g., between 1 micron and about 6 microns) may be less than or equal to about 99%, less than or equal to about 98%, less than or equal to about 96%, less than or equal to about 92%, less than or equal to about 90%, less than or equal to about 85%, less than or equal to about 80%, less than or equal to about 75%, less than or equal to about 70%, less than or equal to about 60%, less than or equal to about 55%, less than or equal to about 50%, less than or equal to about 45%, less than or equal to about 40%, less than or equal to about 35%, less than or equal to about 30%, less than or equal to about 25%, less than or equal to about 20%, or less than or equal to about 15%, e.g., based on the total amount of fibers in a layer. Combinations of the above-referenced ranges are possible (e.g., greater than or equal to about 3% and less than or equal to about 98%, greater than or equal to about 5% and less than or equal to about 96%).

In yet other embodiments, a layer of a filter media may include two or more types of polymeric staple fibers in which both types of polymeric staple fibers have an average fiber diameter of between 1 micron and about 10 microns (e.g., between 1 micron and about 8 microns, between 1 micron and about 6 microns). Each type of polymeric staple fiber may independently have a weight percentage in a range described above, and a fiber diameter in a range described above.

In some embodiments, a layer of the filter media (e.g., a second layer or a third layer, such as a main filtration layer) may have a basis weight of less than or equal to about 500 g/m², less than or equal to about 450 g/m², less than or equal to about 400 g/m², less than or equal to about 350 g/m², less than or equal to about 300 g/m², less than or equal to about 250 g/m², less than or equal to about 200 g/m², less than or equal to about 150 g/m², less than or equal to about 100 g/m², or less than or equal to about 50 g/m². In some embodiments, the basis weight may be greater than or equal to about 5 g/m², greater than or equal to about 10 g/m², greater than or equal to about 25 g/m², greater than or equal to about 50 g/m², greater than or equal to about 100 g/m², greater than or equal to about 150 g/m², greater than or equal to about 200 g/m², greater than or equal to about 250 g/m², greater than or equal to about 300 g/m², greater than or equal to about 350 g/m², greater than or equal to about 400 g/m², or greater than or equal to about 450 g/m². Combinations of the above-referenced ranges are also possible (e.g., greater than or equal to about 5 g/m² and less than or equal to about 500 g/m², greater than or equal to about 10 g/m² and less than or equal to about 400 g/m²). Other values of basis weight are also possible. As determined herein, the basis weight of the filter media is measured according to the Technical Association of the Pulp and Paper Industry (TAPPI) Standard T410. The values are expressed in grams per square meter or pounds per 3,000 square feet. Basis weight can generally be measured on a laboratory balance that is accurate to 0.1 grams.

In some embodiments, a layer of the filter media (e.g., a second layer or a third layer, such as a main filtration layer) may have a relatively high dust holding capacity. In some embodiments, the second layer may have a DHC of greater than or equal to about 5 g/m², greater than or equal to about 10 g/m², greater than or equal to about 20 g/m², greater than or equal to about 40 g/m², greater than or equal to about 60 g/m², greater than or equal to about 80 g/m², greater than or equal to about 100 g/m², greater than or equal to about 125 g/m², greater than or equal to about 150 g/m², greater than or equal to about 175 g/m², greater than or equal to about 200 g/m², greater than or equal to about 225 g/m², greater than or equal to about 250 g/m², greater than or equal to about 275 g/m², or greater than or equal to about 300 g/m². In some instances, the DHC of the second layer may be less than or equal to about 350 g/m², less than or equal to about 325 g/m², less than or equal to about 300 g/m², less than or equal to about 275 g/m², less than or equal to about 250 g/m², less than or equal to about 225 g/m², less than or equal to about 200 g/m², less than or equal to about 180 g/m², less than or equal to about 150 g/m², less than or equal to about 125 g/m², less than or equal to about 100 g/m², or less than or equal to about 75 g/m². Combinations of the above-referenced ranges are also possible (e.g., a DHC of greater than about 10 g/m² and less than or equal to about 350 g/m², a DHC of greater than about 20 g/m² and less than or equal to about 300 g/m², a DHC of greater than about 10 g/m² and less than or equal to about 200 g/m², a DHC of greater than about 10 g/m² and less than or equal to about 200 g/m²). Other values of dust holding capacity are also possible. Dust holding capacity can be measured as described in more detail below.

The air permeability of a layer of the filter media (e.g., a second layer or a third layer, such as a main filtration layer) can also be varied as desired. For instance, in some embodiments, the layer (e.g., a second layer or a third layer, such as a main filtration layer) may have an air permeability of greater than or equal to about 1 cfm/sf, greater than or equal to about 3 cfm/sf, greater than or equal to about 5 cfm/sf, greater than or equal to about 10 cfm/sf, greater than or equal to about 25 cfm/sf, greater than or equal to about 50 cfm/sf, greater than or equal to about 100 cfm/sf, greater than or equal to about 150 cfm/sf, greater than or equal to about 200 cfm/sf, or greater than or equal to about 250 cfm/sf. In some instances, the layer may have an air permeability of less than or equal to about 300 cfm/sf, less than or equal to about 275 cfm/sf, less than or equal to about 250 cfm/sf, less than or equal to about 225 cfm/sf, less than or equal to about 200 cfm/sf, less than or equal to about 175 cfm/sf, less than or equal to about 150 cfm/sf, less than or equal to about 125 cfm/sf, less than or equal to about 100 cfm/sf, less than or equal to about 75 cfm/sf, less than or equal to about 50 cfm/sf, or less than or equal to about 25 cfm/sf. Combinations of the above-referenced ranges are also possible (e.g., greater than or equal to about 1 cfm/sf and less than or equal to about 300 cfm/sf, greater than or equal to about 3 cfm/sf and less than or equal to about 250 cfm/sf). The air permeability can be measured as described in more detail below.

In some embodiments, a layer of the filter media (e.g., a second layer or a third layer, such as a main filtration layer), and/or an overall filter media may have a relatively small pressure drop. For instance, in some embodiments, the pressure drop of may be less than or equal to about 80 kPa, less than or equal to about 70 kPa, less than or equal to about 60 kPa, less than or equal to about 50 kPa, less than or equal to about 40 kPa, less than or equal to about 30 kPa, less than or equal to about 20 kPa, less than or equal to about 10 kPa, less than or equal to about 4.5 kPa, or less than or equal to about 1 kPa. In some instances, the pressure drop may be greater than or equal to about 0.05 kPa, greater than or equal to about 0.1 kPa, greater than or equal to about 0.5 kPa, greater than or equal to about 1 kPa, greater than or equal to about 5 kPa, greater than or equal to about 10 kPa, greater than or equal to about 20 kPa, greater than or equal to about 30 kPa, greater than or equal to about 40 kPa, or greater than or equal to about 50 kPa. Combinations of the above-referenced ranges are also possible (e.g., greater than or equal to about 0.05 kPa and less than or equal to about 80 kPa, greater than or equal to about 0.1 kPa and less than or equal to about 50 kPa). As used herein, the pressure drop refers to a flatsheet pressure drop determined using ISO 3968. The pressure drop value is measured with clean hydraulic fluid at 15 cSt with a face velocity of 0.67 cm/s.

In some embodiments, a layer of the filter media (e.g., a second layer or a third layer, such as a main filtration layer), and/or an overall filter media may have a mean flow pore size of greater than or equal to about 0.1 micron, greater than or equal to about 0.2 microns, greater than or equal to about 0.5 microns, greater than or equal to about 1 microns, greater than or equal to about 10 microns, greater than or equal to about 30 microns, greater than or equal to about 50 microns, greater than or equal to about 70 microns, greater than or equal to about 90 microns, greater than or equal to about 110 microns, or greater than or equal to about 130 microns. In some instances, the second layer and/or the overall filter media may have an average mean flow pore size of less than or equal to about 150 microns, less than or equal to about 140 microns, less than or equal to about 120 microns, less than or equal to about 100 microns, less than or equal to about 80 microns, less than or equal to about 60 microns, less than or equal to about 40 microns, less than or equal to about 20 microns, less than or equal to about 10 microns, less than or equal to about 5 microns, less than or equal to about 1 micron, or less than or equal to about 0.5 microns. Combinations of the above-referenced ranges are also possible (e.g., greater than or equal to about 0.1 micron and less than or equal to about 150 microns, greater than or equal to about 0.2 micron and less than or equal to about 100 microns, greater than or equal to about 0.2 micron and less than or equal to about 10 microns). As used herein, the mean flow pore size refers to the mean flow pore size measured by using a Capillary Flow Porometer manufactured by Porous Materials, Inc. in accordance with the ASTM F316-03 standard.

As described in more detail below, the efficiency of a layer or media can be expressed in terms of a beta ratio, or a micron rating for beta efficiency. In some embodiments, a layer of the filter media (e.g., a second layer or a third layer, such as a main filtration layer), and/or the overall filter media may have a relatively low micron rating for beta efficiency (e.g., beta 200); that is, the minimum particle size for achieving a particular efficiency (e.g., a beta 200 efficiency or an efficiency of 99.5%) may be relatively low. For instance, in some instances, the micron rating for beta efficiency (e.g., beta 200) may be less than or equal to about 30 microns, less than or equal to about 28 microns, less than or equal to about 25 microns, less than or equal to about 24 microns, less than or equal to about 22 microns, less than or equal to about 20 microns, less than or equal to about 18 microns, less than or equal to about 16 microns, less than or equal to about 14 microns, less than or equal to about 12 microns, less than or equal to about 10 microns, less than or equal to about 8 microns, or less than or equal to about 5 microns. In some embodiments, the micron rating for beta efficiency (e.g., beta 200) may be greater than or equal to about 1 micron, greater than or equal to 2 microns, greater than or equal to 3 microns, greater than or equal to about 4 microns, greater than or equal to about 5 microns, greater than or equal to about 6 microns, greater than or equal to about 8 microns, greater than or equal to about 10 microns, greater than or equal to about 12 microns, greater than or equal to about 15 microns, greater than or equal to about 20 microns, or greater than or equal to about 25 microns. Combinations of the above-referenced ranges are possible (e.g., greater than or equal to about 1 micron and less than or equal to about 20 microns, greater than or equal to about 4 microns and less than or equal to about 10 microns). The micron rating for beta efficiency may be determined using the testing described for dust holding capacity and efficiency described herein.

In some embodiments, a layer (e.g., the first layer, and optionally the third layer), may be a pre-filter. In some such embodiments, the pre-filter layer(s) may be wet laid or non-wet laid (e.g., formed of a non-wet laid process such as a dry laid, meltblown, meltspinning, centrifugal spinning, electrospinning, spunbond, or air laid process). In some embodiments, the layer includes fibers formed of a synthetic polymer. Additionally or alternatively, a pre-filter layer may include glass fibers as described herein. It should be understood that the filter media may comprise any suitable number of pre-filter layers (e.g., at least 1, at least 2, at least 3, at least 4, at least 6, at least 8, at least 10 layers).

In certain embodiments, a pre-filter (which may include one or more layers) may have an average fiber diameter of between about 0.1 to about 40 microns, a basis weight of between about 5 gsm to about 450 gsm, a mean flow pore size of between about 4 microns to about 100 microns, and an air permeability of between about 10 cfm/sf to about 800 cfm/sf. Other ranges are also possible, as described in more detail below.

In general, the pre-filter layer(s) may be formed from any suitable fibers. Regardless of the fiber type, the average diameter of the fibers in a pre-filter layer may be, for example, greater than or equal to about 0.1 microns, greater than or equal to about 0.3 microns, greater than or equal to about 0.5 microns, greater than or equal to about 1 micron, greater than or equal to about 5 microns, greater than or equal to about 10 microns, greater than or equal to about 15 microns, greater than or equal to about 20 microns, greater than or equal to about 25 microns, greater than or equal to about 30 microns, or greater than or equal to about 35 microns. In some embodiments, the average diameter of the fibers in the pre-filter layer may be, for example, less than or equal to about 40 microns, less than or equal to about 35 microns, less than or equal to about 30 microns, less than or equal to about 25 microns, less than or equal to about 20 microns, less than or equal to about 15 microns, less than or equal to about 10 microns, less than or equal to about 5 microns, less than or equal to about 3 microns, less than or equal to about 1 micron, or less than or equal to about 0.5 microns. Combinations of the above-referenced ranges are also possible.

In some embodiments, regardless of the fiber content, the basis weight of one or more pre-filter layers may be greater than or equal to about 5 g/m², greater than or equal to about 10 g/m², greater than or equal to about 25 g/m², greater than or equal to about 50 g/m², greater than or equal to about 100 g/m², greater than or equal to about 150 g/m², greater than or equal to about 200 g/m², greater than or equal to about 250 g/m², greater than or equal to about 300 g/m², greater than or equal to about 350 g/m², greater than or equal to about 400 g/m², or greater than or equal to about 450 g/m². In some instances, the basis weight of one or more pre-filter layers may be less than or equal to about 500 g/m², less than or equal to about 450 g/m², less than or equal to about 400 g/m², less than or equal to about 350 g/m², less than or equal to about 300 g/m², less than or equal to about 250 g/m², less than or equal to about 200 g/m², less than or equal to about 150 g/m², less than or equal to about 100 g/m², or less than or equal to about 50 g/m². Combinations of the above-referenced ranges are also possible (e.g., greater than or equal to about 5 g/m² and less than or equal to about 500 g/m², greater than or equal to about 10 g/m² and less than or equal to about 400 g/m²). Other values of basis weight are also possible.

In some embodiments, the dust holding capacity of one or more pre-filter layers, or a combination of pre-filter layers (e.g., a dual-layer pre-filter), may be greater than or equal to about 20 g/m², greater than or equal to about 50 g/m², greater than or equal to about 80 g/m², greater than or equal to about 100 g/m², greater than or equal to about 125 g/m², greater than or equal to about 150 g/m², greater than or equal to about 175 g/m², greater than or equal to about 200 g/m², greater than or equal to about 225 g/m², greater than or equal to about 250 g/m², greater than or equal to about 275 g/m², or greater than or equal to about 300 g/m². In some instances, the DHC may be less than or equal to about 350 g/m², less than or equal to about 325 g/m², less than or equal to about 300 g/m², less than or equal to about 275 g/m², less than or equal to about 250 g/m², less than or equal to about 225 g/m², less than or equal to about 200 g/m², less than or equal to about 180 g/m², less than or equal to about 150 g/m², less than or equal to about 125 g/m², less than or equal to about 100 g/m², or less than or equal to about 75 g/m². Combinations of the above-referenced ranges are also possible (e.g., a DHC of greater than about 20 g/m² and less than or equal to about 300 g/m², a DHC of greater than about 50 g/m² and less than or equal to about 300 g/m²,). Other values of dust holding capacity are also possible.

In some embodiments, one or more pre-filter layers may have a micron rating for beta efficiency (e.g., beta 200) of greater than or equal to about 4 microns, greater than or equal to 5 microns, greater than or equal to about 6 microns, greater than or equal to about 8 microns, greater than or equal to about 10 microns, greater than or equal to about 12 microns, greater than or equal to about 15 microns, greater than or equal to about 20 microns, or greater than or equal to about 25 microns. In some instances, the micron rating for beta efficiency (e.g., beta 200) may be less than or equal to about 30 microns, less than or equal to about 28 microns, less than or equal to about 25 microns, less than or equal to about 24 microns, less than or equal to about 22 microns, less than or equal to about 20 microns, less than or equal to about 18 microns, less than or equal to about 16 microns, less than or equal to about 14 microns, less than or equal to about 12 microns, less than or equal to about 10 microns, or less than or equal to about 8 microns. Combinations of the above-referenced ranges are possible (e.g., greater than or equal to about 4 microns and less than or equal to about 30 microns).

In some embodiments, one or more pre-filter layers may have a mean flow pore size of greater than or equal to about 4 microns, greater than or equal to about 5 microns, greater than or equal to about 6 microns, greater than or equal to about 10 microns, greater than or equal to about 20 microns, greater than or equal to about 30 microns, greater than or equal to about 40 microns, greater than or equal to about 50 microns, greater than or equal to about 65 microns, or greater than or equal to about 80 microns. In some instances, one or more pre-filter layers may have a mean flow pore size of less than or equal to about 100 microns, less than or equal to about 90 microns, less than or equal to about 80 microns, less than or equal to about 70 microns, less than or equal to about 60 microns, less than or equal to about 50 microns, less than or equal to about 40 microns, less than or equal to about 25 microns, or less than or equal to about 10 microns. Combinations of the above-referenced ranges are also possible (e.g., greater than or equal to about 4 microns and less than or equal to about 100 microns, greater than or equal to about 5 microns and less than or equal to about 90 microns).

The air permeability of one or more pre-filter layers can also be varied as desired. For instance, in some embodiments, one or more pre-filter layers, or a combination of pre-filter layers (e.g., a dual-layer pre-filter), may have an air permeability of greater than or equal to about 10 cfm/sf, greater than or equal to about 25 cfm/sf, greater than or equal to about 50 cfm/sf, greater than or equal to about 100 cfm/sf, greater than or equal to about 150 cfm/sf, greater than or equal to about 200 cfm/sf, greater than or equal to about 250 cfm/sf, greater than or equal to about 300 cfm/sf, greater than or equal to about 350 cfm/sf, greater than or equal to about 400 cfm/sf, greater than or equal to about 500 cfm/sf, greater than or equal to about 600 cfm/sf, or greater than or equal to about 700 cfm/sf. In some instances, one or more pre-filter layers, or a combination of pre-filter layers (e.g., a dual-layer pre-filter), may have an air permeability of less than or equal to about 800 cfm/sf, less than or equal to about 700 cfm/sf, less than or equal to about 600 cfm/sf, less than or equal to about 500 cfm/sf, less than or equal to about 400 cfm/sf, less than or equal to about 375 cfm/sf, less than or equal to about 350 cfm/sf, less than or equal to about 325 cfm/sf, less than or equal to about 300 cfm/sf, less than or equal to about 275 cfm/sf, less than or equal to about 250 cfm/sf, less than or equal to about 225 cfm/sf, less than or equal to about 200 cfm/sf, less than or equal to about 175 cfm/sf, less than or equal to about 150 cfm/sf, less than or equal to about 125 cfm/sf, less than or equal to about 100 cfm/sf, less than or equal to about 75 cfm/sf, or less than or equal to about 50 cfm/sf. Combinations of the above-referenced ranges are also possible (e.g., greater than or equal to about 10 cfm/sf and less than or equal to about 800 cfm/sf, greater than or equal to about 10 cfm/sf and less than or equal to about 400 cfm/sf, greater than or equal to about 30 cfm/sf and less than or equal to about 350 cfm/sf).

In some embodiments, filter media 5 of FIG. 1 and/or filter media 10 of FIG. 2 is designed such that the average fiber diameters of each layer are different. For example, the ratio of average fiber diameters between two layers (e.g., between a first layer and a second layer, between a second layer and a third layer, between a first layer and a third layer, or between an upstream layer and a downstream layer, etc.) may be less than 10:1, less than 7:1, less than 5:1, less than 4:1, less than 3:1, less than 2:1, or 1:1. Small differences in average fiber diameters between two layers may, in some instances, lead to relatively low resistance ratios between the layers. In turn, relatively low resistance ratios between the layers can result in the filter media having favorable properties such as high dust holding capacity at relatively low basis weights, as described in more detail below.

Alternatively, two layers may have larger differences in average fiber diameters. For example, the ratio of average fiber diameters between two layers (e.g., between a first layer and a second layer, between a second layer and a third layer, or between a first layer and a third layer, etc.) may be greater than 1:1, greater than 2:1, greater than 3:1, greater than 4:1, greater than 5:1, greater than 7:1, or greater than 10:1.

The first, second or third layer can generally have any suitable thickness. In some embodiments, the first, second or third layer may have a thickness of at least about 5 microns (e.g., at least about 10 microns, at least about 20 microns, at least about 30 microns, at least about 50 microns, at least about 80 microns, at least about 100 microns), and/or less than or equal to about 500 microns (e.g., less than or equal to about 400 microns, less than or equal to about 200 microns, less than or equal to about 180 microns, less than or equal to about 150 microns). For example, the layer may have a thickness from about 5 microns to about 500 microns (e.g., from about 5 microns to about 250 microns, from about 10 microns to about 200 microns, from about 20 microns to about 150 microns, from about 30 microns to about 500 microns, from about 50 microns to about 100 microns). Combinations of the above-referenced ranges are also possible for each layer, and for different layers within a filter media. Thickness, as referred to herein, is determined according to TAPPI T411 using an appropriate caliper gauge (e.g., a Model 200-A electronic microgauge manufactured by Emveco, tested at 1.5 psi). In some cases, if the thickness of a layer cannot be determined using an appropriate caliper gauge, visual techniques such as scanning electron microscopy in cross-section view can be used.

As described herein, in addition to or in place of glass fibers, one or more layers of the filter media may include components such as synthetic fibers (e.g., synthetic polymer fibers). For instance, one or more layers of filter media 5 of FIG. 1 or filter media 10 of FIG. 2 may include a relatively high percentage of synthetic fibers, e.g., at least about 50 wt %, at least about 60 wt %, at least about 70 wt %, at least about 80 wt %, at least about 90 wt %, at least about 95 wt %, at least about 97 wt %, or at least about 99 wt %, or 100 wt % synthetic fibers (e.g., synthetic polymer fibers). In some cases, at least two layers of the filter media, or the entire filter media, includes such percentages of synthetic fibers. Advantageously, synthetic fibers may be beneficial for resistance to moisture, heat, long-term aging, and microbiological degradation. In other embodiments, synthetic fibers comprise a small weight percentage of the filter media. For example, one or more layers of the filter media may include less than or equal to about 25 wt %, less than or equal to about 15 wt %, less than or equal to about 5 wt %, or less than or equal to about 2 wt % of synthetic fibers. In some cases, one or more layers of a filter media do not include any synthetic fiber. It should be understood that it may also be possible for synthetic fibers to be incorporated within the filter media outside of the ranges disclosed. The synthetic fibers may enhance adhesion of the glass fibers within the web during processing. Synthetic fibers may be, for example, binder fibers, bicomponent fibers (e.g., bicomponent binder fibers) and/or staple fibers.

In general, the synthetic fibers in any layer may have any suitable composition. In some cases, the synthetic fibers comprise a thermoplastic. Non-limiting examples of the synthetic polymers that can be used to form fibers include PVA (polyvinyl alcohol), polyester (e.g., polybutylene terephthalate, polybutylene naphthalate, polycaprolactone), polyethylene, polypropylene, acrylic, polyolefin, polyamides (e.g., nylon), rayon, polycarbonates, polyphenylene sulfides, polystyrenes, polybutylene terephthalate, and polyurethanes (e.g., thermoplastic polyurethanes), regenerated cellulose, cellulose acetate, polymethyl methacrylate, polyaniline, polyaramid (e.g. para-aramid, meta-aramid), polyimide (e.g., polyetherimide), polyether ketone, polyethylene terephthalate, polyolefin, polyacrylics, polyether sulfones, poly(phenylene ether sulfone), polysulfones, polyacrylonitrile, polyvinylidene fluoride, poly(lactic acid), polyphenylene oxide, polypyrrole, zein, and combinations or copolymers (e.g., block copolymers) thereof. Optionally, the polymer(s) or copolymer(s) may contain fluorine atoms. Examples of such polymers include PVDF, PVDF-HFP (hexafluoropropylene) and PTFE. It should be appreciated that other appropriate synthetic fibers may also be used. In some embodiments, the synthetic fiber is chemically stable with hydraulic fluids for hydraulic applications. The synthetic fiber may be formed by any suitable process such as meltblown, meltspun, melt electrospinning and/or solvent electrospinning processes.

In one set of embodiments, the synthetic fibers are bicomponent fibers. Each component of the bicomponent fiber can have a different melting temperature. For example, the fibers can include a core and a sheath where the activation temperature of the sheath is lower than the melting temperature of the core. This allows the sheath to melt prior to the core, such that the sheath binds to other fibers in the layer, while the core maintains its structural integrity. This is particularly advantageous in that it creates a more cohesive layer for trapping filtrate. The core/sheath binder fibers can be concentric or non-concentric, and exemplary core/sheath binder fibers can include the following: a polyester core/copolyester sheath, a polyester core/polyethylene sheath, a polyester core/polypropylene sheath, a polypropylene core/polyethylene sheath, and combinations thereof. Other exemplary bicomponent fibers can include split fiber fibers, side-by-side fibers, and/or “island in the sea” fibers.

Alternatively, one or more layers of the filter media can include other fiber types such as cellulose pulp fibers (e.g., wood pulp fibers) and carbon fibers.

The filter media may also include a binder. The binder typically comprises a small weight percentage of the filter media. For example, the binder may comprise less than or equal to about 10 wt %, or less than or equal to about 5 wt % (e.g., between about 2 wt % and about 5 wt %) of the filter media. In some embodiments, the binder may be about 4 wt % of the filter media. As described further below, the binder may be added to the fibers in the wet fiber web state. In some embodiments, the binder coats the fibers and is used to adhere fibers to each other to facilitate adhesion between the fibers.

In general, the binder may have any suitable composition. In some embodiments, the binder is resin-based. The binder may be in the form of one or more components, for example, the binder may be in the form of bicomponent fibers such as the ones described above. Though, it should be understood that not all embodiments include all of these components and that other appropriate additives may be incorporated.

In addition to the binder, glass components, and synthetic components described above, the filter media may include a variety of other suitable additives (typically, in small weight percentages) such as, surfactants, coupling agents, crosslinking agents, amongst others.

The fiber media may have a variety of desirable properties and characteristics which make it particularly well-suited for hydraulic applications. However, it should be understood that the filter media described herein are not limited to hydraulic applications, and that the media can be used in other applications such as for air filtration or filtration of other liquids and gases.

A filter media, including one or more layers of the filter media, can also have varying basis weights, pore sizes, thicknesses, permeabilities, dust holding capacities, efficiencies, and pressure drop, depending upon the requirements of a desired application.

The overall basis weight of a filter media can vary depending on factors such as the strength requirements of a given filtering application, the number of layers in the filter media, the position of the layer (e.g., upstream, downstream, middle), and the materials used to form the layer, as well as the desired level of filter efficiency and permissible levels of resistance or pressure drop. In certain embodiments described herein, increased performance (e.g., lower resistance or pressure drop) is observed when the filter media includes multiple layers having different properties, where each layer has a relatively low basis weight, compared to certain single- or multi-layered media. As a result, some such filter media may also have a lower overall basis weight while achieving high performance characteristics. For example, the overall basis weight of a filter media (or of two or more layers of the filter media) may be less than or equal to about 700 g/m², less than or equal to about 600 g/m², less than or equal to about 500 g/m², less than or equal to about 400 g/m², less than or equal to about 300 g/m², less than or equal to about 200 g/m², less than or equal to about 150 g/m², less than or equal to about 125 g/m², less than or equal to about 100 g/m², less than or equal to about 80 g/m², or less than or equal to about 50 g/m².

Generally, the ratio of basis weights between two different layers of a filter media (e.g., between a first layer and a second layer, between a second layer and a third layer, between a first layer and a third layer, etc.) can vary depending on the desired properties of the filter media. In some embodiments, an upstream layer of a filter media (e.g., a pre-filter layer) has a larger basis weight than that of a downstream layer (e.g., a main filter layer). For example, the ratio of basis weights between an upstream layer and a downstream layer may be greater than 1:1, greater than 1.5:1, or greater than 2:1. In other embodiments, however, an upstream layer of a filter media has a smaller basis weight than that of a downstream layer, e.g., the ratio of basis weights between an upstream layer and a downstream layer may be less than 2:1, less than 1.5:1, or less than 1:1. In certain embodiments, the basis weight ratio of an upstream and a downstream layer is 1:1.

The overall thickness of a filter media may be between about 5 mils and 300 mils, e.g., between about 50 mils and about 200 mils. The thickness of a layer of the filter media may be between about 3 mils and about 100 mils, between about 3 mils and about 70 mils, between about 3 mils and about 60 mils, between about 3 mils and about 50 mils, between about 3 mils and about 40 mils, between about 3 mils and about 30 mils, between about 3 mils and about 20 mils, or between about 3 mils and about 10 mils.

The overall air permeability of a filter media described herein can usually be selected as desired. In some embodiments, the overall permeability of the filter media, may range from between about 2 cubic feet per minute per square foot (cfm/sf) and about 300 cfm/sf, between about 7 cfm/sf and about 200 cfm/sf, between about 15 cfm/sf and about 135 cfm/sf, between about 15 cfm/sf and about 50 cfm/sf, between about 2 cfm/sf and about 50 cfm/sf, or between about 10 cfm/sf and about 40 cfm/sf. The overall permeability of the filter media may be, for example, greater than or equal to about 5 cfm/sf, greater than or equal to about 10 cfm/sf, greater than or equal to about 25 cfm/sf, greater than or equal to about 50 cfm/sf, greater than or equal to about 100 cfm/sf, greater than or equal to about 150 cfm/sf, greater than or equal to about 200 cfm/sf, or greater than or equal to about 250 cfm/sf. In some instances, the air permeability may be, for example, less than or equal to about 300 cfm/sf, less than or equal to about 275 cfm/sf, less than or equal to about 250 cfm/sf, less than or equal to about 225 cfm/sf, less than or equal to about 200 cfm/sf, less than or equal to about 175 cfm/sf, less than or equal to about 150 cfm/sf, less than or equal to about 125 cfm/sf, less than or equal to about 100 cfm/sf, less than or equal to about 75 cfm/sf, less than or equal to about 50 cfm/sf, or less than or equal to about 25 cfm/sf. Combinations of the above-referenced ranges are also possible. As determined herein, the permeability of the filter media is measured according to TAPPI Method T251. The permeability of a filter media is an inverse function of flow resistance and can be measured with a Frazier Permeability Tester. The Frazier Permeability Tester measures the volume of air per unit of time that passes through a unit area of sample at a fixed differential pressure across the sample. Permeability can be expressed in cubic feet per minute per square foot at a 0.5 inch water differential.

Typically, an upstream layer has a larger permeability (lower resistance) and/or a smaller pressure drop than that of a downstream layer, although other configurations are possible.

Certain filter media can have relatively low resistance ratios or certain ranges of resistance ratios between two layers that provide favorable filtration properties. For instance, the resistance ratio between a second layer, which includes fibers having a small average diameter, and a first layer, which includes fibers having a relatively larger average diameter, may be relatively low. In some cases, the second layer is downstream of the first layer as shown in FIG. 2. For example, in one particular embodiment, the second layer is a main filter layer and the first layer is a pre-filter layer. In another embodiment, the second layer is a downstream main filter layer and the first layer is an upstream filter layer. Other combinations are also possible. The resistance ratio between two layers (e.g., between a second layer and a first layer, between a downstream layer and an upstream layer, between a main layer and a pre-filter layer, or between two main layers, etc.), calculated as the resistance of the layer having a relatively smaller average fiber diameter to the resistance of the layer having a relatively larger average fiber diameter, may be, for example, between 0.5:1 and 15:1, between 1:1 and 10:1, between 1:1 and 7:1, between 1:1 and 5:1, or between 1:1 and 3.5:1. In some cases, the resistance ratio between the two layers is less than 15:1, less than 12:1, less than 10:1, less than 8:1, less than 6:1, less than 5:1, less than 4:1, less than 3:1, or less than 2:1, e.g., while being above a certain value, such as greater than 0.01:1, greater than 0.1:1, or greater than 1:1. Advantageously, certain ranges of resistance ratios (including low resistance ratios in some embodiments) can result in the filter media having favorable properties such as high dust holding capacity and/or high efficiency, while maintaining a relatively low overall basis weight. Such characteristics can allow the filter media to be used in a variety of applications.

In one particular set of embodiments, the resistance ratio between a main filter layer and a pre-filter layer adjacent (e.g., directly adjacent) the main filter layer of a filter media is between 0.5:1 and 7:1, between 1:1 and 5:1, or between 1:1 and 3.5:1. If the filter media includes another main filter layer, the resistance ratio between the downstream main filter layer to the upstream main filter layer may be between 1:1 and 12:1, between 1:1 and 8:1, between 1:1 and 6:1, or between 1:1 and 4:1. Additional layers are also possible.

The resistance of a layer may be normalized against the basis weight of the layer to produce a normalized resistance (e.g., resistance of a layer divided by the basis weight of the layer). In some cases, a normalized resistance ratio between two layers, e.g., a second layer, which includes fibers having a small average diameter, and a first layer, which includes fibers having a relatively larger average diameter, is relatively low. For example, in one particular embodiment, the second layer is a main filter layer and the first layer is a pre-filter layer. In another embodiment, the second layer is a downstream main filter layer and the first layer is an upstream filter layer. Other combinations are also possible. The normalized resistance ratio between two layers (e.g., between a second layer and a first layer, between a downstream layer and an upstream layer, between a main layer and a pre-filter layer, between two pre-filter layers, or between two main layers, etc.), calculated as the normalized resistance of the layer having a relatively smaller average fiber diameter to the normalized resistance of the layer having a relatively larger average fiber diameter, may be, for example, between 1:1 and 15:1, between 1:1 and 10:1, between 1:1 and 8:1, between 1:1 and 5:1, between 3:1 and 6:1, or between 1:1 and 3:1. In some cases, the normalized resistance ratio between the two layers is less than 15:1, less than 12:1, less than 10:1, less than 8:1, less than 6:1, less than 5:1, less than 4:1, less than 3:1, or less than 2:1, e.g., while being above a certain value, such as greater than 0.01:1, greater than 0.1:1, greater than 1:1, or greater than 3:1.

In one particular set of embodiments, the normalized resistance ratio between a main filter layer and a pre-filter layer adjacent (e.g., directly adjacent) the main filter layer of a filter media is between 1:1 and 8:1, between 1:1 and 5:1, between 3:1 and 6:1, or between 1:1 and 3:1. If the filter media includes another main filter layer, the resistance ratio between the downstream main filter layer to the upstream main filter layer may be between 1:1 and 10:1, between 1:1 and 8:1, between 1:1 and 6:1, between 1:1 and 4:1, between 3:1 and 6:1, or between 3:1 and 4:1. Additional layers are also possible.

In another particular set of embodiments, a filter media includes a normalized resistance ratio of a second layer to a first layer of 4:1 or greater, and a normalized resistance ratio of a third layer to a second layer of 4:1 or less. In some embodiments, a filter media includes a normalized resistance ratio of a second layer to a first layer of between 4:1 and 6:1, and a normalized resistance ratio of a third layer to a second layer of between 2:1 and 4:1. In some cases, the third layer in such embodiments includes a synthetic polymer fiber having one of the weight percentages described herein.

A filter media described herein can also have good dust holding properties. For example, a filter media can have an overall dust holding capacity (DHC) of at least about 25 g/m², at least about 50 g/m², at least about 100 g/m², at least about 120 g/m², at least about 140 g/m², at least about 150 g/m², at least about 160 g/m², at least about 180 g/m², at least about 200 g/m², at least about 220 g/m², at least about 240 g/m², at least about 260 g/m², at least about 280 g/m², at least about 300 g/m², or at least about 350 g/m². The dust holding capacity may be, for example, less than 500 g/m². The dust holding capacity, as referred to herein, is tested based on a Multipass Filter Test following the ISO 16889 procedure (modified by testing a flat sheet sample) on a Multipass Filter Test Stand manufactured by FTI. The testing uses ISO A3 Medium test dust manufactured by PTI, Inc. at an upstream gravimetric dust level of 10 mg/liter. The test fluid is Aviation Hydraulic Fluid AERO HFA MIL H-5606A manufactured by Mobil. The test was run at a face velocity of 0.67 cm/w until a terminal pressure of 500 kPa above the baseline filter pressure drop is obtained. The dust holding capacity can be calculated at 200 kPa by interpolation.

The dust holding capacity of a filter media can be normalized against the basis weight of the media to produce a specific capacity (e.g., dust holding capacity of the media divided by the basis weight of the media). The specific capacity of the filter media described herein may range, for example, between 0.3 and 3.0, between 1.5 and 3.0, between 1.7 and 2.7, or between 1.8 and 2.5. In certain embodiments, the specific capacity of a filter media is greater than or equal to 0.3, greater than or equal to 0.5, greater than or equal to 0.8, greater than or equal to 1.0, greater than or equal to 1.2, greater than or equal to 1.5, greater than or equal to 1.6, greater than or equal to 1.7, greater than or equal to 1.8, greater than or equal to 1.9, greater than or equal to 2.0, greater than or equal to 2.1, greater than or equal to 2.2, greater than or equal to 2.3, greater than or equal to 2.4, greater than or equal to 2.5, greater than or equal to 2.6, greater than or equal to 2.7, greater than or equal to 2.8, greater than or equal to 2.9, or greater than or equal to 3.0. The specific capacity may be less than or equal to 5.0, less than or equal to 4.0, less than or equal to 3.0, or less than or equal to 2.0 in some embodiments. Combinations of the above-ranges are also possible.

The dust holding capacity of a filter media may also be normalized against the overall basis weight of the media and the log of the filtration ratio (Beta₍ₓ₎) for certain particle sizes “x” or greater to produce a unitless value, “Absolute specific capacity at x microns”. For example, for a filter media that captures particle sizes of 10 microns or greater and which has a certain Beta₍₁₀₎ value, the “Absolute specific capacity at 10 microns” for that media would be calculated by multiplying the dust holding capacity of the media by the square root of the log of the Beta₍ₓ₎ value for 10 micron and larger particles, and dividing by the overall basis weight of the media.

In certain embodiments, a filter media having two (or more) layers has an absolute specific capacity at 10 microns of greater than or equal to about 0.02, greater than or equal to about 0.1, greater than or equal to about 0.2, greater than or equal to about 0.5, greater than or equal to about 1.0, greater than or equal to about 1.5, greater than or equal to about 2.0, greater than or equal to about 2.5, greater than or equal to about 2.65, greater than or equal to about 2.7, greater than or equal to about 2.75, greater than or equal to about 3.0, greater than or equal to about 3.4, greater than or equal to about 3.5, greater than or equal to about 3.6, greater than or equal to about 3.75, greater than or equal to about 4.0, greater than or equal to about 4.25, greater than or equal to about 4.5, greater than or equal to about 4.75, or greater than or equal to about 5.0. The absolute specific capacity at 10 microns may be, for example, less than or equal to about 6.0, less than or equal to about 5.0, less than or equal to about 4.0, less than or equal to about 3.0 or less than or equal to about 2.0. Combinations of the above-ranges are also possible. The filter media may additionally have a total basis weight of, for example, less than or equal to about 600 g/m², less than or equal to about 500 g/m², less than or equal to about 400 g/m², less than or equal to about 300 g/m², less than or equal to about 200 g/m², less than or equal to about 150 g/m², less than or equal to about 100 g/m², less than or equal to about 90 g/m², less than or equal to about 80 g/m², less than or equal to about 75 g/m², less than or equal to about 70 g/m², less than or equal to about 68 g/m², less than or equal to about 65 g/m², less than or equal to about 60 g/m², or less than or equal to about 50 g/m². Other values and ranges of absolute specific capacity and basis weight are also possible.

In certain embodiments, a filter media having three (or more) layers has an absolute specific capacity at 10 microns of greater than about 2.0, greater than about 2.25, greater than about 2.5, greater than about 2.6, greater than about 2.65, greater than about 2.75, greater than about 3.0, greater than about 3.5, greater than about 3.75, greater than about 4.0, greater than about 4.25, or greater than about 4.5. The filter media may additionally have a total basis weight of, for example, less than or equal to about 600 g/m², less than or equal to about 500 g/m², less than or equal to about 400 g/m², less than or equal to about 300 g/m², less than or equal to about 200 g/m², less than or equal to about 190 g/m², less than or equal to about 180 g/m², less than or equal to about 170 g/m², less than or equal to about 160 g/m², less than or equal to about 150 g/m², less than or equal to about 140 g/m², less than or equal to about 130 g/m², less than or equal to about 120 g/m², less than or equal to about 110 g/m², less than or equal to about 100 g/m², less than or equal to about 90 g/m², or less than or equal to about 80 g/m². Other values and ranges of absolute specific capacity and basis weight are also possible.

In some embodiments, a filter media described herein includes a relatively high overall dust holding capacity, such as one of the values described above, and a relatively high overall permeability, such as one of the values described above. For instance, a filter media may have an overall dust holding capacity of at least about 150 g/m² (e.g., at least about 180 g/m², at least about 200 g/m², at least about 230 g/m², at least about 250 g/m²), and an overall permeability of greater than about 25 cfm/sf (e.g., greater than about 30 cfm/sf, greater than about 35 cfm/sf, greater than about 40 cfm/sf, greater than about 45 cfm/sf, or greater than about 50 cfm/sf). In certain embodiments, these performance characteristics are achieved with a filter media including a third layer comprising a blend of polymeric staple fibers and glass fibers.

The filter media described herein may be used for the filtration of various particle sizes, e.g., particles having a size of less than or equal to about 20 microns, less than or equal to about 15 microns, less than or equal to about 10 microns, less than or equal to about 5 microns, less than or equal to about 3 microns, or less than or equal to about 1 micron. The efficiency of filtering such particle sizes can be measured using a Multipass Filter Test. For instance, the efficiency values can be determined following the ISO 16889 procedure (modified by testing a flat sheet sample) on a Multipass Filter Test Stand manufactured by FTI. The testing uses ISO A3 Medium test dust manufactured by PTI, Inc. at an upstream gravimetric dust level of 10 mg/liter. The test fluid is Aviation Hydraulic Fluid AERO HFA MIL H-5606A manufactured by Mobil. The test can be run at a face velocity of 0.67 cm/s until a terminal pressure of 500 kPa. Particle counts (particles per milliliter) at the particle sized selected (e.g., 1, 3, 4, 5, 7, 10, 15, 20, 25, or 30 microns) upstream and downstream of the media can be taken at ten points equally divided over the time of the test. The average of upstream and downstream particle counts can be taken at each selected particle size. From the average particle count upstream (injected—C₀) and the average particle count downstream (passed thru—C) the liquid filtration efficiency test value for each particle size selected can be determined by the relationship [(1−[C/C₀])*100%].

Efficiency can also be expressed in terms of a beta value (or beta ratio), where beta₍ₓ₎=y is the ratio of upstream count (C₀) to downstream count (C), and where x is the minimum particle size that will achieve the actual ratio of C₀ to C that is equal to y. The penetration fraction of the media is 1 divided by the beta₍ₓ₎ value (y), and the efficiency fraction is 1−penetration fraction. Accordingly, the efficiency of the media is 100 times the efficiency fraction, and 100*(1−1/beta₍ₓ₎)=efficiency percentage. For example, a filter media having a beta₍ₓ₎=200 has an efficiency of [1−( 1/200)]*100, or 99.5% for x micron or larger particles. The filter media described herein may have a wide range of beta values, e.g., a beta₍ₓ₎=y, where x can be, for example, 1, 3, 5, 7, 10, 12, 15, 20, 25, 30, 50, 70, or 100, and where y can be, for example, at least 2, at least 10, at least 75, at least 100, at least 200, or at least 1000. It should be understood that other values of x and y are also possible; for instance, in some cases, y may be greater than 1000. It should also be understood that for any value of x, y may be any number (e.g., 10.2, 12.4) representing the actual ratio of C₀ to C. Likewise, for any value of y, x may be any number representing the minimum particle size that will achieve the actual ratio of C₀ to C that is equal to y.

The efficiency of a media or a layer of media may also be referred to as having a particular micron rating, x, for a certain beta efficiency (e.g., beta 200), meaning that the media or layer has that efficiency (e.g., beta 200=99.5% efficiency) for trapping x micron or larger particles. Generally, a lower micron rating means that the media or layer is able to trap smaller particles or is more “efficient” than a media or layer having a relatively larger micron rating. Unless otherwise stated, a micron rating described herein is determined for a beta 200 efficiency (i.e., the average micron size at a terminal pressure of 500 kPa based on the Multipass Filter Test described above).

The filter media described herein may be produced using processes based on known techniques. In some cases, one or more layers of the filter media is produced using a wet laid process. In general, a wet laid process involves mixing together the fibers; for example, glass fibers (e.g., chopped strand and/or microglass) may be mixed together, optionally with any synthetic fibers, to provide a glass fiber slurry. In some cases, the slurry is an aqueous-based slurry. In certain embodiments, the microglass fibers, and optionally any chopped strand and/or synthetic fibers, are stored separately in various holding tanks prior to being mixed together. These fibers may be processed through a pulper before being mixed together. In some embodiments, combinations of chopped strand glass fibers, microglass fibers, and/or synthetic fibers are processed through a pulper and/or a holding tank prior to being mixed together. As discussed above, microglass fibers may include fine microglass fibers and coarse microglass fibers.

It should be appreciated that any suitable method for creating a glass fiber slurry may be used. In some cases, additional additives are added to the slurry to facilitate processing. The temperature may also be adjusted to a suitable range, for example, between 33° F. and 100° F. (e.g., between 50° F. and 85° F.). In some embodiments, the temperature of the slurry is maintained. In some cases, the temperature is not actively adjusted.

In some embodiments, the wet laid process uses similar equipment as a conventional papermaking process, which includes a hydropulper, a former or a headbox, a dryer, and an optional converter. For example, the slurry may be prepared in one or more pulpers. After appropriately mixing the slurry in a pulper, the slurry may be pumped into a headbox, where the slurry may or may not be combined with other slurries or additives may or may not be added. The slurry may also be diluted with additional water such that the final concentration of fiber is in a suitable range, such as for example, between about 0.1% to 0.5% by weight.

In some cases, the pH of the fiber slurry may be adjusted as desired. For instance, the pH of the fiber slurry may range between about 1 to about 8 depending on the particular amounts of glass and/or polymeric staple fibers used.

Before the slurry is sent to a headbox, the slurry may be passed through centrifugal cleaners for removing unfiberized glass or shot. The slurry may or may not be passed through additional equipment such as refiners or deflakers to further enhance the dispersion of the fibers. Fibers may then be collected on a screen or wire at an appropriate rate using any suitable machine, e.g., a fourdrinier, a rotoformer, a cylinder, or an inclined wire fourdrinier. In some embodiments, the wet-laid layer(s) can be formed on a scrim or other suitable substrate directly.

In some embodiments, the process involves introducing binder (and/or other components) into a pre-formed layer. In some embodiments, as the fiber layer is passed along an appropriate screen or wire, different components included in the binder, which may be in the form of separate emulsions, are added to the fiber layer using a suitable technique. In some cases, each component of the binder resin is mixed as an emulsion prior to being combined with the other components and/or fiber layer. In some embodiments, the components included in the binder may be pulled through the fiber layer using, for example, gravity and/or vacuum. In some embodiments, one or more of the components included in the binder resin may be diluted with softened water and pumped into the fiber layer.

As noted above, different layers of glass and/or other fibers may be combined to produce filter media based on desired properties. For example, in some embodiments, a relatively coarse pre-filter layer may be combined with a relatively finer fiber layer (i.e., a main filter layer) to form a multi-layered filter media. Optionally, the filter media can include one or more additional fine fiber layers as described above.

Multi-phase filter media may be formed in an appropriate manner. As an example, a filter media or a portion thereof may be prepared by a wet laid process where a first fiber slurry (e.g., fibers in an aqueous solvent such as water) is applied onto a wire conveyor to form a first layer. A second fiber slurry (e.g., fibers in an aqueous solvent such as water) is then applied onto the first layer either simultaneously or downstream in the manufacturing process of where the first fiber slurry is placed on the wire. Vacuum may be continuously applied to the first and second slurries during the above process to remove solvent from the fibers, resulting in the simultaneous formation of the first and second layers into a composite article. The composite article is then dried. Due to this fabrication process, at least a portion of the fibers in the first layer can be intertwined with at least a portion of the fibers from the second layer (e.g., at the interface between the two layers). Additional layers can also be formed and added using a similar process or a different process such as lamination, co-pleating, or collation (i.e., placed directly adjacent one another and kept together by pressure). For example, in some cases, two layers (e.g., two fine fiber layers) are formed into a composite article by a wet laid process in which separate fiber slurries are laid one on top of the other as water is drawn out of the slurry, and the composite article is then combined with a third layer (e.g., a pre-filter layer) by any suitable process (e.g., lamination, co-pleating, or collation). It can be appreciated that filter media or composite article formed by a wet laid process may be suitably tailored not only based on the components of each fiber layer, but also according to the effect of using multiple fiber layers of varying properties in appropriate combination to form filter media having the characteristics described herein.

In one set of embodiments, at least two layers of a filter media (e.g., a layer and a composite article comprising more than one layer, or two composite articles comprising more than one layer) are laminated together. For instance, a first layer (e.g., a prefilter layer including relatively coarse fibers) may be laminated with a second layer (e.g., a main filter layer including relatively fine fibers), where the first and second layers face each other to form a single, multilayer article (e.g., a composite article) that is integrally joined in a single process line assembly operation to form the filter media. If desired, the first and second layers can be combined with another main filter layer (e.g., a third layer) using any suitable process before or after the lamination step. In other embodiments, two or more layers (e.g., main filter layers) are laminated together to form a multilayer article. After lamination of two or more layers into a composite article, the composite article may be combined with additional layers via any suitable process.

In other embodiments, a non-wet laid process, such as an air laid or dry-laid process, is used. In an air laid process, glass fibers are chopped and dispersed in air that is blown onto a conveyor, and a binder is then applied. Air laid processing is typically more suitable for the production of highly porous media including bundles of fibers (e.g., glass fibers).

For some embodiments, one or more layers (e.g., a first layer or third layer, such as a pre-filter layer) of a filter media described herein may be produced from a meltblown process. For example, meltblown processes and manufacturing methods described in U.S. Patent Publication No. 2009/0120048, entitled “Meltblown Filter Medium,” which is incorporated herein by reference in its entirety for all purposes, may be used, including the lamination techniques described therein. Electrospinning processes, melt spun processes, centrifugal spinning processes, or spun bond processes may also be used to form one or more layers described herein. Other processes are also possible. A synthetic polymer layer may be manufactured and adhered on to a single-phase or multi-phase layer in any appropriate manner. In some embodiments, a layer including a synthetic polymer may be positioned downstream with respect to a single-phase or multi-phase layer or vice versa.

During or after formation of a layer, a composite article including two or more combined layers, or a final filter media, the layer, composite article or final filter media may be further processed according to a variety of known techniques. For example, the filter media or portions thereof may be pleated and used in a pleated filter element. For instance, two layers may be joined by a co-pleating process. In some embodiments, filter media, or various layers thereof, may be suitably pleated by forming score lines at appropriately spaced distances apart from one another, allowing the filter media to be folded. It should be appreciated that any suitable pleating technique may be used. The physical and mechanical qualities of the filter media can be tailored to provide, in some embodiments, an increased number of pleats, which may be directly proportional to increased surface area of the filter media. The increased surface area may allow the filter media to have an increased filtration efficiency of particles from fluids. For example, in some cases, the filter media described herein includes 2-12 pleats per inch, 3-8 pleats per inch, or 2-5 pleats per inch. Other values are also possible.

It should be appreciated that the filter media may include other parts in addition to the two or more layers described herein. In some embodiments, further processing includes incorporation of one or more structural features and/or stiffening elements. For instance, the media may be combined with additional structural features such as polymeric and/or metallic meshes. In one embodiment, a screen backing may be disposed on the filter media, providing for further stiffness. In some cases, a screen backing may aid in retaining the pleated configuration. For example, a screen backing may be an expanded metal wire or an extruded plastic mesh.

As previously indicated, the filter media disclosed herein can be incorporated into a variety of filter elements for use in various applications including hydraulic and non-hydraulic filtration applications. Exemplary uses of hydraulic filters (e.g., high-, medium-, and low-pressure filters) include mobile and industrial filters. Exemplary uses of non-hydraulic filters include fuel filters (e.g., automotive fuel filters), oil filters (e.g., lube oil filters or heavy duty lube oil filters), chemical processing filters, industrial processing filters, medical filters (e.g., filters for blood), air filters, and water filters. In some cases, filter media described herein can be used as coalescer filter media.

In some cases, the filter element includes a housing that may be disposed around the filter media. The housing can have various configurations, with the configurations varying based on the intended application. In some embodiments, the housing may be formed of a frame that is disposed around the perimeter of the filter media. For example, the frame may be thermally sealed around the perimeter. In some cases, the frame has a generally rectangular configuration surrounding all four sides of a generally rectangular filter media. The frame may be formed from various materials, including for example, cardboard, metal, polymers, or any combination of suitable materials. The filter elements may also include a variety of other features known in the art, such as stabilizing features for stabilizing the filter media relative to the frame, spacers, or any other appropriate feature.

In one set of embodiments, the filter media described herein is incorporated into a filter element having a cylindrical configuration, which may be suitable for hydraulic and other applications. The cylindrical filter element may include a steel support mesh that can provide pleat support and spacing, and which protects against media damage during handling and/or installation. The steel support mesh may be positioned as an upstream and/or downstream layer. The filter element can also include upstream and/or downstream support layers that can protect the filter media during pressure surges.

These layers can be combined with filter media 10, which may include two or more layers as noted above. The filter element may also have any suitable dimensions. For example, the filter element may have a length of at least 15 inches, at least 20 inches, at least 25 inches, at least 30 inches, at least 40 inches, or at least 45 inches. The surface area of the filter media may be, for example, at least 220 square inches, at least 230 square inches, at least 250 square inches, at least 270 square inches, at least 290 square inches, at least 310 square inches, at least 330 square inches, at least 350 square inches, or at least 370 square inches.

The filter elements may have the same property values as those noted above in connection with the filter media. For example, the above-noted resistance ratios, basis weight ratios, dust holding capacities, efficiencies, specific capacities, and fiber diameter ratios between various layers of the filter media may also be found in filter elements.

During use, the filter media mechanically trap particles on or in the layers as fluid flows through the filter media. The filter media need not be electrically charged to enhance trapping of contamination. Thus, in some embodiments, the filter media are not electrically charged. However, in some embodiments, the filter media may be electrically charged.

The following examples are intended to illustrate certain embodiments of the present invention, but are not to be construed as limiting and do not exemplify the full scope of the invention.

### Example 1

This example shows that a composite filter media including a pre-filter containing two glass fiber layers and a main filtration layer formed of a blend of glass fibers and polymeric staple fibers had a lower micron rating for beta 200 efficiency and a similar dust holding capacity compared to a composite filter media including pre-filter containing two glass fiber layers and a main filtration layer that contained only glass fibers.

In the main filtration layers containing a blend of glass fibers and polymeric staple fibers, polyester staple fibers having a diameter between 1-3 microns and/or 4-7 microns and a length of about 1.5 mm were used in the amounts specified in Table 1. The glass fibers had an average diameter between 2-6 microns. The main filtration layers were formed using a wet laid handsheet process. A total mass of about 4.16 grams of fibers was used to make each fiber web. The handsheet process was performed by acidifying the entire volume of the handsheet mold and pulping the fibers in acidified water to form a fiber slurry. The fiber slurry was then added to the top of the handsheet mold, the slurry was agitated, and the slurry was allowed to drain through the forming wire. The remaining wet fiber web was vacuumed and dried on a photodryer.

The pre-filter contained two layers (e.g., primary layer and a secondary layer) formed by a wet laid papermaking process. The wet laid papermaking process involved forming a primary fiber slurry comprising glass fibers having a diameter between about 2-6 microns and forming a secondary fiber slurry comprising glass fibers having a diameter between about 6-9 microns. The primary and secondary slurries were held in a first and a second holding chest, respectively. HYCAR 26120 resin was formed and held in a storage tank. Slurry from the first holding chest was pumped to the main headbox of a fourdrinier paper machine. The slurry was allowed to flow onto the forming wire of the paper machine and was drained by gravity, as well as by a series of vacuum slots eventually forming a wet, loosely bonded web of fibers which was carried away by the forming wire. To make the second layer, fiber from the second holding chest was pumped, along with dilution water, to a secondary headbox also located on the fourdrinier paper making machine. The secondary headbox was positioned so that the forming wire carrying the drained fibers from the main headbox passed underneath the secondary headbox. The second slurry laid on top of, and then drained through, the already formed web from the main headbox. The water was then removed by another series of vacuum slots resulting in a combined single web including fibers from the main headbox as a bottom layer and fibers from the secondary headbox as a top layer. In some cases, the combined single web was then sprayed with a resin solution to add binder. The web was then dried by passing over a series of steam filled dryer cans. The total basis weight of the pre-filter was 85 gsm. The pre-filter had an air permeability of 85 cfm/sf. The pre-filter and the main filtration layer were combined by collation to form the composite media.

After the composite filter media were dried, the dust holding capacity and efficiency of each filter media was determined using the ISO 16889 procedure that was modified by testing each filter media sample on a Multipass Filter Test Stand manufactured by FTI. The test used ISO A3 Medium test dust manufactured by PTI, Inc. at an upstream gravimetric dust level of 10 mg/liter. The test fluid was Aviation Hydraulic Fluid AERO HFA MIL H-5606A, manufactured by Mobil. The tests were run at a face velocity of 0.67 cm/s until a terminal pressure of 500 kPa absolute. The dust holding capacity was measured at 200 kPa after the completion of the test.

Prior to beginning of each Multipass test, the pressure drop (clean flatsheet DP) across each filter media was determined. The pressure drop was measured using the ISO 3968 standard. The pressure drop value was measured when clean hydraulic fluid at 15 cSt with a face velocity of 0.67 cm/s was passing through the filter media.

The weight percentage of glass fibers and polymeric staple fibers and basis weight for the main filtration layers are shown in Table 1. The dust holding capacity, pressure drop, and efficiency of the overall composite including the pre-filter layer and main filtration layer are also shown in Table 1.

TABLE 1
Structural and performance characteristics of composite filter media

| | | | | | Micron | | |
|---|---|---|---|---|---|---|---|
| | | Polymeric | Polymeric | | rating | | |
| | | Staple | Staple | | for Beta | | Clean |
| | Glass | Fibers | Fibers | Basis | 200 | | Flat |
| | Fibers | (1-3 μm) | (4-7 μm) | weight | efficiency | DHC | sheet |
| Media | wt. %* | wt. %* | wt. %* | (g/m²)* | (μm)** | (g/m²)** | DP (kPa)** |
| 1 | 100 | 0 | 0 | 39.6 | 17.8 | 191.5 | 0.7 |
| 2 | 50 | 0 | 50 | 36.0 | 16 | 172.2 | 0.9 |
| 3 | 50 | 50 | 0 | 38.9 | 10.1 | 199 | 2.9 |
| 4 | 67 | 17 | 17 | 39.2 | 13.8 | 187.2 | 1.0 |
| 5 | 17 | 17 | 67 | 34.8 | 13.4 | 191.7 | 1.4 |
| 6 | 17 | 67 | 17 | 37.6 | 8.8 | 187.9 | 3.2 |
| 7 | 33 | 33 | 33 | 22.6 | 11.2 | 203.8 | 1.8 |

*Values refer to those for main filtration layer only
**Values refer to those for the overall composite including the pre-filter layer and main filtration layer

This example shows that the micron rating for beta 200 efficiency for composite filter media containing a blend of glass fibers and polymeric staple fibers (i.e., media 2-7) was lower by about 10% to 50% compared to a composite filter media including a pre-filter containing two glass fiber layers and a main filtration layer that contained only glass fibers (i.e., media 1). A lower micron rating means that the main filtration layers containing a blend of glass fibers and polymeric staple fibers were able to trap smaller particles, e.g., compared to the main filtration layer in media 1. For example, media 6 was 99.5% efficient for trapping 8.8 micron-sized or larger particles, whereas media 1 was 99.5% efficient for only 17.8 micron-sized or larger particles. The efficiency for trapping particles smaller than 17.8 microns would be lower than 99.5% in media 1. All composite media had similar dust holding capacity values and basis weights.

### Example 2

This example shows that a composite filter media including a pre-filter containing two glass fiber layers and a main filtration layer formed of a blend of glass fibers and polymeric staple fibers having a diameter of less than 1 micron and/or between 1-3 microns had a lower micron rating for beta 200 efficiency and a similar dust holding capacity compared to a composite filter media including a main filtration layer that contained only glass fibers.

Main filtration layers containing glass fibers and polymeric staple fibers were formed using the method described in Example 1, except polymeric staple fibers having a diameter of less than 1 micron and a length of about 40 microns were used in some main filtration layers in the amounts specified in Table 2. Pre-filter layers were formed using the method described in Example 1, and collated to the main filtration layer.

The dust holding capacity, pressure drop, and efficiency of the overall composite including the pre-filter layer and main filtration layer are shown in Table 2. The dust holding capacity and efficiency of composite media were measured using the methods described in Example 1.

The weight percentage of glass and polymeric staple fibers and basis weight for the main filtration layers are also shown in Table 2.

TABLE 2
Structural and performance characteristics of composite filter media

| | | Polymeric | Polymeric | | Micron | | Clean |
|---|---|---|---|---|---|---|---|
| | | Staple | Staple | | rating for | | Flat |
| | Glass | Fibers* | Fibers* | Basis | Beta 200 | | sheet |
| | Fibers* | (1-3 μm) | (<1 μm) | weight* | efficiency** | | DP** |
| Media | wt. % | wt. % | wt. % | (g/m²) | (μm) | DHC** (g/m²) | (kPa) |
| 1 | 100 | 0 | 0 | 39.6 | 17.8 | 191.5 | 0.7 |
| 8 | 75 | 0 | 25 | 40.0 | 8.6 | 168 | 5.1 |
| 9 | 75 | 25 | 0 | 42.0 | 11.2 | 193 | 2.2 |
| 10 | 80 | 10 | 10 | 40.0 | 12.0 | 189 | 2.2 |
| 11 | 75 | 12.5 | 12.5 | 37.0 | 12.2 | 193 | 2.5 |
| 12 | 80 | 20 | 0 | 41.0 | 12.5 | 195 | 1.6 |

*Values refer to those for main filtration layer only
**Values refer to those for the overall composite including the pre-filter layer and main filtration layer

This example shows that composite filter media including a pre-filter containing two glass fiber layers and a main filtration layer formed of a blend of glass fibers and polymeric staple fiber having a diameter of less than 1 micron and/or between 1-3 microns (e.g., media 8-12) had a lower micron rating for beta 200 efficiency and similar dust holding capacity compared composite filter media including pre-filter containing two glass fiber layers and a main filtration layer of similar basis weight that contained glass only (e.g., media 1).

Additionally, composite media having a main filtration layer containing glass fibers and polymeric staple fibers having a diameter of less than 1 micron (e.g., media webs 8, 10, 11) had a lower micron rating for beta 200 efficiency than composite media having a main filtration layer containing only glass fibers (e.g., media 1) and composite media having a main filtration layer containing glass fibers and staple fibers having a diameter between 1-3 microns (e.g., media 9, 12). The most dramatic difference was observed with media 8, which showed a micron rating for beta 200 efficiency that was lower by about 52% compared to a composite media having a main filtration layer that contained only glass fibers (i.e., media 1).

### Example 3

This example shows that a composite filter media including a pre-filter containing two glass fiber layers and a main filtration layer formed of a blend of glass fibers and polymeric staple fiber had a higher dust holding capacity and similar low micron rating for beta 200 efficiency and pressure drop, compared to a composite filter media including a pre-filter containing two glass fiber layers and a main filtration layer formed of meltblown fibers.

The pre-filter contained two layers (e.g., primary layer and a secondary layer) formed by a wet laid papermaking process as described in Example 1.

The main filtration layers in media 13-17 were formed of a blend of glass fibers and polymeric staple fiber in the amounts specified in Table 3 using the wet laid papermaking process described in Example 1 for the pre-filter, except only one layer was formed. Some filter media were sprayed with 5% Hycar 26120 binder resin saturant to add binder. The glass fibers and 1-3 micron polyester staple fibers described in Example 1 were used to form the main filtration layer.

The main filtration layer in media 18 was formed by forming meltblown fibers on a scrim. The meltblown fibers had an average diameter of 1.5 microns. The meltblown fibers formed a layer having a basis weight of about 21 g/m². The scrim had a basis weight of 15 g/m².

The weight percentage of glass and polymeric staple fibers and basis weight in the main filtration layers are also shown in Table 3. The dust holding capacity, pressure drop, and efficiency of the overall composites including the pre-filter layer and main filtration layer are also shown in Table 3. These values were measured according to the methods described in Example 1.

TABLE 3
Structural and performance characteristics of filter media

| | | | | | Micron | | Clean |
|---|---|---|---|---|---|---|---|
| | | Polymeric | | | rating | | Flat |
| | Glass | Staple | | | for Beta | | Sheet |
| | fibers | Fibers* (1-3 μm) | Basic weight | Binder | 200 | DHC | DP |
| Media | wt. %* | wt. % | (lb/ream)** | Resin | (μm)** | (g/m²)** | (kPa)** |
| 13 | 80 | 20 | 46.1 | Yes | 12.6 | 201 | 1.8 |
| 14 | 70 | 30 | 45.1 | Yes | 11.8 | 199 | 2.2 |
| 15 | 75 | 25 | 46.1 | Yes | 12.1 | 206 | 1.9 |
| 16 | 80 | 20 | 43.0 | No | 12.6 | 196 | 1.8 |
| 17 | 75 | 25 | 43.0 | No | 12.3 | 193 | 1.9 |
| 18 | 0 | 0 | 38 | | 11.5 | 150 | 2.0 |

*Values refer to those for main filtration layer only
**Values refer to those for the overall composite including the pre-filter layer and main filtration layer

This example shows that composite filter media including a pre-filter containing two glass fiber layers and a main filtration layer comprising a blend of glass fibers and polymeric staple fibers (e.g., media 13-17) had comparable micron ratings for beta 200 efficiency and pressure drop compared to a composite media of similar basis weight but having a meltblown main filtration layer (e.g., media 18). The dust holding capacities of media 13-17 were higher than the dust holding capacity of media 18.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A filter media comprising:
a first layer; and
a second layer comprising glass fibers and polymeric staple fibers,
wherein the polymeric staple fibers have an average fiber diameter of less than or equal to about 10 microns,
wherein the glass fibers are present in the second layer in an amount of at least about 0.5 wt % to about 99.5 wt % of the fibers in the second layer,
wherein the polymeric staple fibers are present in the second layer in an amount of at least about 0.5 wt % to about 99.5 wt % of the fibers in the second layer, and
wherein the first layer has a mean flow pore size greater than a mean flow pore size of the second layer.

2. A filter media comprising:
a non-woven layer comprising a blend of glass fibers and polymeric staple fibers,
wherein the polymeric staple fibers have an average fiber diameter of less than or equal to about 6 microns.

3. A filter media comprising:
a non-woven layer comprising a blend of glass fibers and polymeric staple fibers,
wherein the polymeric staple fibers have an average fiber diameter of less than or equal to about 10 microns, and wherein the polymeric staple fibers are present in an amount of greater than or equal to about 10 wt % of the fibers in the non-woven layer.

4. The filter media of claim 1, wherein the polymeric staple fibers have an average fiber diameter of less than or equal to about 6 microns.

5. The filter media of claim 1, wherein the polymeric staple fibers have an average fiber diameter of less than or equal to about 4 microns.

6. The filter media of claim 1, wherein the polymeric staple fibers have an average fiber diameter of less than or equal to about 3 microns.

7. The filter media of claim 1, wherein the first layer comprises glass fibers.

8. The filter media of claim 1, wherein the polymeric staple fibers have an average length of less than or equal to about 5 mm.

9. The filter media of claim 1, wherein the polymeric staple fibers have an average length of less than or equal to about 500 microns.

10. The filter media of claim 1, wherein the first layer is a non-wet laid layer.

11. The filter media of claim 1, wherein the first layer is a wet laid layer.

12. The filter media of claim 1, wherein the first layer comprises meltblown fibers, melt spun fibers, and/or centrifugal spun fibers.

13. The filter media of claim 1, wherein the polymeric staple fibers are present in the second layer in an amount of at least about 10 wt %.

14. The filter media of claim 1, wherein the filter media has a flat sheet pressure drop of less than or equal to about 4.5 kPa.

15. The filter media of claim 1, wherein the filter media has a dust holding capacity of between about 5 gsm and about 300 gsm.

16. The filter media of claim 1, wherein the filter media has a beta 200 value of less than or equal to about 30 microns.

17. The filter media of claim 1, wherein the filter media has a beta 200 value of less than or equal to about 15 microns.

18. The filter media of claim 1, wherein the glass fibers in the second layer have an average diameter of less than or equal to about 11 microns.

19. The filter media of claim 1, wherein the second layer has a mean flow pore size of between about 0.1 microns and about 10 microns.

20. The filter media of claim 1, wherein the filter media has a basis weight of less than or equal to about 600 gsm.

21. The filter media of claim 1, comprising a third layer comprising glass fibers positioned between the first and second layers.

22. A filter media as in claim 21, wherein at least one of the first and third layers comprises at least about 80 wt % glass fibers.

23. A method, comprising passing a fluid across the filter media of claim 1.

24. A filter element comprising the filter media of claim 1.

25. The filter media of claim 24, wherein the second layer is positioned downstream of the first layer.

26. The filter media of claim 1, wherein the filter media has a normalized resistance ratio of between 3:1 and 6:1 between the first layer and the second layer.

27. The filter media of claim 1, wherein the filter media has an absolute specific capacity at 10 microns of between about 0.5 and about 2.0.

28. The filter media of claim 1, wherein the filter media has a specific capacity of between about 0.5 and about 2.0.
